(19) United States
(12) Patent Application Publication
(10) Pub. No.: US 2025/0321402 A1
(43) Pub. Date: Oct. 16, 2025

(54) OPTICAL SYSTEM AND CAMERA MODULE COMPRISING SAME

(71) Applicant: LG INNOTEK CO., LTD., Seoul (KR)

(72) Inventor: Duk Keun KWON, Seoul (KR)

(73) Assignee: LG INNOTEK CO., LTD., Seoul (KR)

(21) Appl. No.: 18/866,277

(22) PCT Filed: May 18, 2023
(86) PCT No.: PCT/KR2023/006801

§ 371 Date: Nov. 15, 2024

(30) Foreign Application Priority Data
May 18, 2022 (KR) 10-2022-0061128

(51) Int. Cl. G02B 13/00; G02B 9/64

(52) U.S. Cl. CPC G02B 13/0045; G02B 9/64

(57) ABSTRACT

The optical system disclosed in the embodiment of the invention includes first to eighth lenses disposed along an optical axis from an object side to a sensor side, wherein the first lens has positive (+) or negative (−) refractive power on the optical axis, the second lens has positive (+) refractive power on the optical axis, the third lens has negative (−) refractive power on the optical axis, the seventh lens has positive (+) refractive power on the optical axis, the eighth lens has negative (−) refractive power on the optical axis, at least one of an object-side surface and a sensor-side surface of the seventh lens has at least one critical point, each of an object-side surface and a sensor-side surface of the eighth lens has a critical point, at least one of the object-side surface and the sensor-side surface of the eighth lens has a freeform surface shape in which a lens surface orthogonal to the optical axis in a first direction and a lens surface orthogonal to the optical axis in a second direction are asymmetrical, and the freeform surface may have symmetrical lens surfaces on both sides of the first direction with respect to the optical axis and symmetrical lens surfaces on both sides of the second direction with respect to the optical axis.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions.

For example, the optical system of the camera module may include an imaging lens for forming an image, and an image sensor for converting the formed image into an electrical signal. In this case, the camera module may, perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for the camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted.

However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

In addition, the size of the image sensor is increasing to realize high-resolution and high-definition. However, when the size of the image sensor increases, TTL (Total Track Length) of the optical system including the plurality of lenses also increases, thereby increasing the thickness of the camera and the mobile terminal including the optical system.

Therefore, a new optical system capable of solving the above problems is required.

### DISCLOSURE

### Technical Problem

An embodiment of the invention provides an optical system with improved optical properties.

An embodiment provides an optical system having excellent optical performance at the center and periphery portions of the field of view.

An embodiment provides an optical system capable of having a slim structure.

### Technical Solution

An optical system according to an embodiment of the invention comprises first to eighth lenses disposed along an optical axis from an object side to a sensor side, wherein the first lens has positive (+) or negative (−) refractive power on the optical axis, the second lens has positive (+) refractive power on the optical axis, the third lens has negative (−) refractive power on the optical axis, the seventh lens has positive (+) refractive power on the optical axis, the eighth lens has negative (−) refractive power on the optical axis, at least one of an object-side surface and a sensor-side surface of the seventh lens has at least one critical point, each of an object-side surface and a sensor-side surface of the eighth lens has a critical point, at least one of the object-side surface and the sensor-side surface of the eighth lens has a freeform surface shape in which a lens surface orthogonal to the optical axis in a first direction and a lens surface orthogonal to the optical axis in a second direction are asymmetrical, and the freeform surface may have symmetrical lens surfaces on both sides of the first direction with respect to the optical axis and symmetrical lens surfaces on both sides of the second direction with respect to the optical axis.

According to an embodiment of the invention, each of the object-side surface and the sensor-side surface of the seventh lens has a critical point, and the critical point of the object-side surface of the seventh lens may be located closer to the optical axis than the critical point of the sensor-side surface of the seventh lens.

According to an embodiment of the invention, the object-side surface of the seventh lens may have a convex shape on the optical axis, and the sensor-side surface of the seventh lens may have a concave shape on the optical axis.

According to an embodiment of the invention, a sensor-side surface of the third lens may have a concave shape on the optical axis, and the object-side surface of the fourth lens may have a concave shape on the optical axis.

According to an embodiment of the invention, an object-side surface of the fifth lens may have a concave shape on the optical axis, and may have a maximum value of absolute values of curvature radius of lens surfaces of the optical system.

According to an embodiment of the invention, an object-side surface of the second lens has a convex shape on the optical axis, a sensor-side surface of the second lens has a convex shape on the optical axis, and a thickness of the second lens on the optical axis may be the maximum of the thicknesses of the lenses of the optical system.

According to an embodiment of the invention, the sensor-side surface of the eighth lens has a freeform surface, and a distance from the optical axis to the critical point of the sensor-side surface of the eighth lens in the first direction may be different from a distance from the optical axis to the critical point of the sensor-side surface of the eighth lens in the second direction.

According to an embodiment of the invention, the object-side surface of the eighth lens may have an aspheric shape.

According to an embodiment of the invention, an optical axis distance between the seventh lens and the eighth lens is greater than a sum of a center thickness of the seventh lens and a center thickness of the eighth lens, and may be 1.8 times or more than a thickness having the maximum thickness among the first to eighth lenses.

According to an embodiment of the invention, a straight distance InfX82 from the optical axis to the critical point of the sensor-side surface of the eighth lens in the first direction and a straight distance InfY82 from the optical axis to the critical point of the sensor-side surface of the eighth lens in the second direction are different from each other, and the following Equation may satisfies: −0.1<InfX82−InfY82<0.1 and 0.4<TTL/(Imgh*2)<0.7 (Total track length (TTL) is a distance in the optical axis from an apex of the object-side surface of the first lens to an image surface of the image sensor, and Imgh is ½ of the maximum diagonal length of the image sensor).

An optical system according to an embodiment of the invention comprises a first lens group having three or less lenses on an object side; and a second lens group having five or less lenses on the sensor side of the first lens group, wherein the first lens group has a positive (+) refractive power on an optical axis, and the second lens group has a negative (−) refractive power on an optical axis, a number of lenses of the second lens group is less than twice a number of lenses of the first lens group, a lens closest to the second lens group among the lens surfaces of the first and second lens groups has the minimum effective diameter, the last lens closest to the image sensor among the lens surfaces of the first and second lens groups has the maximum effective diameter, a sensor-side surface closest to the second lens group among the first lens groups has a concave shape, an object-side surface closest to the first lens group among the second lens group has a concave shape, the sensor-side surface of the last lens has a freeform surface shape with a critical point, a sensor-side surface closest to the image sensor has a freeform surface shape in which a lens surface orthogonal to the optical axis in a first direction and a lens surface orthogonal to the optical axis in a second direction are asymmetrical, and the freeform surface may have symmetrical lens surfaces on both sides of the first direction with respect to the optical axis and symmetrical lens surfaces on both sides of the second direction with respect to the optical axis.

According to an embodiment of the invention, a straight distance InfX82 from the optical axis to the critical point of the sensor-side surface of the last lens in the first direction and a straight distance InfY82 from the optical axis to the critical point of the sensor-side surface of the last lens in the second direction are different from each other, and the following Equation may satisfy:

$$- 0.1 < InfX 82 - InfY 82 < 0.1 . \qquad Equation$$

According to an embodiment of the invention, a total focal length FX in the first direction and a total focal length FY in the second direction are different from each other, and the following Equation may satisfy:

$$- 0.1 < FX - FY < 0.1 . \qquad Equation$$

According to an embodiment of the invention, the following Equation satisfy: 0.4<TTL/(Imgh*2)<0.7 (TTL (Total track length) is a distance in the optical axis from the apex of the object-side surface of the first lens to an image surface of the image sensor, and Imgh is ½ of the maximum diagonal length of the image sensor).

According to an embodiment of the invention, the first lens group includes first to third lenses disposed along the optical axis from the object side toward the sensor side, and the second lens group includes fourth to eighth lenses disposed along the optical axis from the object side toward the sensor side, each of an object-side surface and a sensor-side surface of the seventh lens may have a critical point, and an object-side surface of the eighth lens may have a critical point.

According to an embodiment of the invention, a straight distance Inf71 from the optical axis to the critical point of the object-side surface of the seventh lens and a straight distance Inf72 from the optical axis to the critical point of the sensor-side surface of the seventh lens may be satisfied the following Equation:

$$0.7 < Inf 71 / Inf 72 < 1.2 . \qquad ( Equation )$$

According to an embodiment of the invention, the straight distance Inf71 from the optical axis to the critical point of the object-side surface of the seventh lens and an average Inf82 of the straight distances InfX82 and InfY82 from the optical axis to the critical points in X and Y directions of the sensor-side surface of the eighth lens may satisfy the following Equation:

$$0.7 < Inf 71 / Inf 82 < 1.2 . \qquad Equation$$

According to an embodiment of the invention, the seventh lens has positive (+) refractive power and has a convex object-side surface and a concave sensor-side surface, and the eight lens has negative (−) refractive power and has convex object-side surface and a concave sensor-side surface.

According to an embodiment of the invention, an average Inf82 of straight distances InfX82 and InfY82 to the critical points in the X and Y directions of the sensor-side surface of the eighth lens and a straight distance D82 from the optical axis of the eighth lens to an end of the effective region may satisfy the following Equation:

$$0.2 < Inf 82 / D 82 < 0.8 . \qquad Equation$$

According to an embodiment of the invention, a center thickness L2_CT of the second lens and a center thickness L3_CT of the third lens may satisfy the following Equation:

$$1 < L2\_CT / L3\_CT < 5. \qquad ( Equation )$$

According to an embodiment of the invention, the optical axis distance between the seventh lens and the eighth lens may be 1.8 times or more of the center thickness of the second lens.

A camera module according to an embodiment of the invention comprises an image sensor; and a filter between the image sensor and the last lens of the optical system, wherein the optical system includes an optical system disclosed above and may satisfy the following Equation:

$$0.5 < F / TTL < 1.2 \qquad ( Equation )$$

(F is an average of the total focal lengths in two directions orthogonal to the optical axis of the optical system, and TTL (Total track length) is a distance on the optical axis from the apex of the object-side surface of the first lens to the image surface of the image sensor).

### Advantageous Effects

The optical system and the camera module according to the embodiment may have improved optical properties. In detail, the optical system may have improved aberration characteristics and resolving power according to the surface shape, refractive power, thickness of a plurality of lenses and distance between adjacent lenses of a plurality of lenses.

The optical system and the camera module according to the embodiment may have improved distortion and aberration characteristics, and may have good optical performance at the center and periphery portions of the FOV.

The optical system according to the embodiment may have improved optical characteristics and a small total track length (TTL), so that the optical system and a camera module including the same may be provided in a slim and compact structure.

### DESCRIPTION OF DRAWINGS

FIG. 1 is a configuration diagram of an optical system and a camera module according to an embodiment(s) of the invention.

FIG. 2 is an explanatory diagram illustrating a relationship between an image sensor, an n-th lens, and an n−1-th lens in a first direction Y of the optical system of FIG. 1.

FIG. 3 is an explanatory diagram illustrating the relationship between an image sensor, an n-th lens, and an n−1-th lens in a second direction X of the optical system of FIG. 1.

FIG. 4 is a table showing lens data according to the first embodiment having the optical system of FIG. 1.

FIG. 5 is an example of aspherical surface coefficients of lenses according to the first embodiment of the invention.

FIG. 6 is a graph showing ray aberration characteristics in the second direction X of the optical system according to the first embodiment of the invention.

FIG. 7 is a graph showing ray aberration characteristics in the first direction Y of the optical system according to the first embodiment.

FIG. 8 is a table showing lens data according to a second embodiment having the optical system of FIG. 1.

FIG. 9 is an example of aspherical surface coefficients of lenses according to a second embodiment of the invention.

FIG. 10 is a graph showing ray aberration characteristics in the second direction X of the optical system according to the second embodiment of the invention.

FIG. 11 is a graph showing ray aberration characteristics in the first direction Y of the optical system according to the first embodiment.

FIG. 12 is a table showing lens data according to a third embodiment having the optical system of FIG. 1.

FIG. 13 is an example of aspherical surface coefficients of lenses according to a third embodiment of the invention.

FIG. 14 is a graph showing ray aberration characteristics in the second direction X of the optical system according to the third embodiment of the invention.

FIG. 15 is a graph showing ray aberration characteristics in the first direction Y of the optical system according to the third embodiment.

FIG. 16 is a table showing Zernike coefficients of the sensor-side surface of the n-th lens of the optical system according to the first, second, and third embodiments of the invention.

FIG. 17 is a diagram showing a distortion grid in an optical system according to an embodiment of the invention.

FIG. 18 is a diagram illustrating that a camera module according to an embodiment is applied to a mobile terminal.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

Further, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B. and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element.

And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean that the lens surface on the optical axis has a convex shape, and a concave surface of the lens may mean that the lens surface on the optical axis has a concave shape. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to +0.4 mm depending on the measurement method. The paraxial region refers to a very narrow region near the optical axis, and is a region in which a distance at which a light ray falls from the optical axis OA is almost zero. Hereinafter, the concave or convex shape of the lens surface will be described as an optical axis, and may also include a paraxial region.

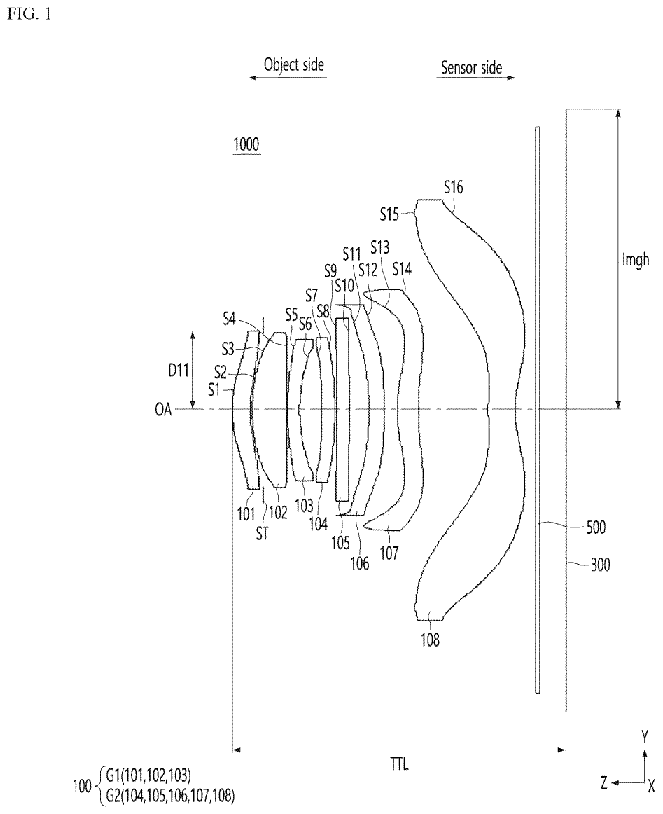

FIG. 1 is a diagram illustrating an optical system 1000 and a camera module having the optical system 1000 according to first to third embodiments of the invention.

Referring to FIG. 1, the optical system 1000 may include a plurality of lens groups G1 and G2. In detail, each of the plurality of lens groups G1 and G2 includes at least one lens. For example, the optical system 1000 may include a first lens group G1 and a second lens group G2 sequentially disposed along the optical axis OA toward the image sensor 300 from the object side. Among the plurality of lens groups G1 and G2, the number of lenses of the second lens group G2 may be greater than the number of lenses of the first lens group G1, for example, more than one time and less than twice the number of lenses in the first lens group G1.

The first lens group G1 may include at least one lens. The first lens group G1 may include three or less lenses. For example, the first lens group G1 may include three lenses. The second lens group G2 may include at least two or more lenses. The second lens group G2 may include more lenses than the number of lenses of the first lens group G1, for example, 1.5 times or more. The second lens group G2 may include seven or less lenses or six lenses or less. The number of lenses of the second lens group G2 may have a difference of three or more and six or less compared to the number of lenses of the first lens group G1. For example, the second lens group G2 may include five lenses.

In the optical system 1000, the total track length (TTL) may be less than 70% of the diagonal length of the image sensor 300, and may be, for example, in the range of 40% to 69% or 50% to 61%. The TTL is a distance on the optical axis OA from the object-side surface of the first lens closest to the object side to the image surface of the image sensor, and the diagonal length of the image sensor 300 is the maximum diagonal length of the image sensor 300, and may be twice a distance Imgh from the optical axis OA to the end of the diagonal. Accordingly, it is possible to provide a slim optical system and a camera module having the same. The total number of lenses of the first and second lens groups G1 and G2 is 7 to 9.

The first lens group G1 may have positive (+) refractive power. The second lens group G2 may have a different negative (−) refractive power from the first lens group G1. The first lens group G1 and the second lens group G2 have different focal lengths and opposite refractive powers, thereby providing good optical performance at the center and the periphery portions of the FOV (Filed of view).

When expressed as an absolute value, the focal length of the second lens group G2 may be greater than that of the first lens group G1. For example, the absolute value of the focal length f_G2 of the second lens group G2 may be 1.4 times or more, for example, in a range of 1.4 to 3.5 times the absolute value of the focal length f_G1 of the first lens group G1. Accordingly, the optical system 1000 according to the embodiment may have improved aberration control characteristics such as chromatic aberration and distortion aberration by controlling the refractive power and focal length of each lens group, and it may have good optical performance at the center and periphery portions of the FOV.

In the optical axis OA, the first lens group G1 and the second lens group G2 may have a set distance. The optical axis distance between the first lens group G1 and the second lens group G2 on the optical axis OA is the separation distance on the optical axis OA, and may be an optical axis distance between the sensor-side surface of the lens closest to the sensor side among the lenses in the first lens group G1 and the object-side surface of the lens closest to the object side among the lenses in the second lens group G2. The optical axis distance between the first lens group G1 and the second lens group G2 may be greater than the center thickness of the last lens of the lenses in the first lens group G1 and the center thickness of the first of the lenses in the second lens group G2. The optical axis distance between the first lens group G1 and the second lens group G2 is smaller than the optical axis distance of the first lens group G1 and may be 20% or more of the optical axis distance of the first lens group G1, for example, in the range of 23% to 53% or 23% to 43% of the optical axis distance of the first lens group G1. Here, the optical axis distance of the first lens group G1 is a distance along the optical axis between the object-side surface of the lens closest to the object side of the first lens group G1 and the sensor-side surface of the lens closest to the sensor side.

The optical axis distance between the first lens group G1 and the second lens group G2 may be 21% or less of the optical axis distance of the second lens group G2, for example, in a range of 5% to 21%. The optical axis distance of the second lens group G2 is a distance along the optical axis between the object-side surface of the lens closest to the object side of the second lens group G2 and the sensor-side surface of the lens closest to the sensor side. A lens having a minimum average effective diameter in the first lens group G1 may be a lens closest to the second lens group G2. A lens having a minimum average effective diameter in the second lens group G2 may be a lens closest to the first lens group G1. Here, the average effective diameter is an average value of an effective diameter of an object-side surface and an effective diameter of a sensor-side surface of the lens. Accordingly, the optical system 1000 may have good optical performance not only at the center portion of the FOV but also at the periphery portion, and chromatic aberration and distortion aberration may be improved. A size of a lens having a minimum effective diameter in the first lens group G1 may be smaller than a size of a lens having a minimum effective diameter in the second lens group G2.

The optical system 1000 may include 10 or less lenses or 9 lenses or less. The first lens group G1 refracts the light incident through the object side to converge, and the second lens group G2 may refract the light emitted through the first lens group G1 so as to diffuse to the periphery portion of the image sensor 300.

The lens closest to the object side among the lenses of the first lens group G1 has positive (+) refractive power, and the lens closest to the sensor side among the lenses of the second lens group G2 may have negative (−) refractive power. In the optical system 1000, the number of lenses having positive (+) refractive power may be greater than the number of lenses having negative (−) refractive power. In the first lens group G1, the number of lenses having positive (+) refractive power may be greater than the number of lenses having negative (−) refractive power. In the second lens group G2, the number of lenses having positive (+) refractive power may be greater than the number of lenses having negative (−) refractive power.

Each of the plurality of lenses 100 may include an effective region and a non-effective region. The effective region may be a region through which light incident to each of the lenses 100 passes. That is, the effective region may be an effective region in which the incident light is refracted to realize optical characteristics. The non-effective region may be arranged around the effective region. The non-effective region may be an area in which effective light from the plurality of lenses 100 is not incident. That is, the non-effective region may be a region unrelated to the optical characteristics. Also, an end of the non-effective region may be a region fixed to a barrel (not shown) accommodating the lens.

The optical system 1000 may include an image sensor 300. The image sensor 300 may detect light and convert it into an electrical signal. The image sensor 300 may detect light sequentially passing through the plurality of lenses 100. The image sensor 300 may include a device capable of sensing incident light, such as a charge coupled device (CCD) or a complementary metal oxide semiconductor (CMOS).

The optical system 1000 may include an optical filter 500. The optical filter 500 may be disposed between the second lens group G2 and the image sensor 300. The optical filter 500 may be disposed between a lens closest to a sensor side among the plurality of lenses 100 and the image sensor 300. For example, when the optical system 100 has eight lenses, the optical filter 500 may be disposed between the eighth lens 110 and the image sensor 300.

The optical filter 500 may include at least one of an infrared filter and an optical filter of a cover glass. The filter 500 may pass light of a set wavelength band and filter light of a different wavelength band. When the optical filter 500 includes an infrared filter, radiant heat emitted from external light may be blocked from being transferred to the image sensor 300. In addition, the optical filter 500 may transmit visible light and reflect infrared light.

The optical system 1000 according to the embodiment may include an aperture stop ST. The aperture stop ST may control the amount of light incident on the optical system 1000. The aperture stop ST may be disposed around the lenses of the first lens group G1. For example, the aperture stop ST may be disposed around an object-side surface or a sensor-side surface of the first lens 101 closest to the object side. The aperture stop ST may be disposed between two adjacent lenses 101 and 102 among the lenses in the first lens group G1. For example, the aperture stop ST may be located around the sensor side of the first lens closest to the object side. Alternatively, at least one lens selected from among the plurality of lenses 100 may serve as an aperture stop. In detail, an object-side surface or a sensor-side surface of one lens selected from among the lenses of the first lens group G1 may serve as an aperture stop for adjusting the amount of light.

The optical system 1000 according to the embodiment may further include a reflective member (not shown) for changing a path of light. The reflection member may be implemented as a prism that reflects incident light of the first lens group G1 toward the lenses. Hereinafter, an optical system according to an embodiment will be described in detail.

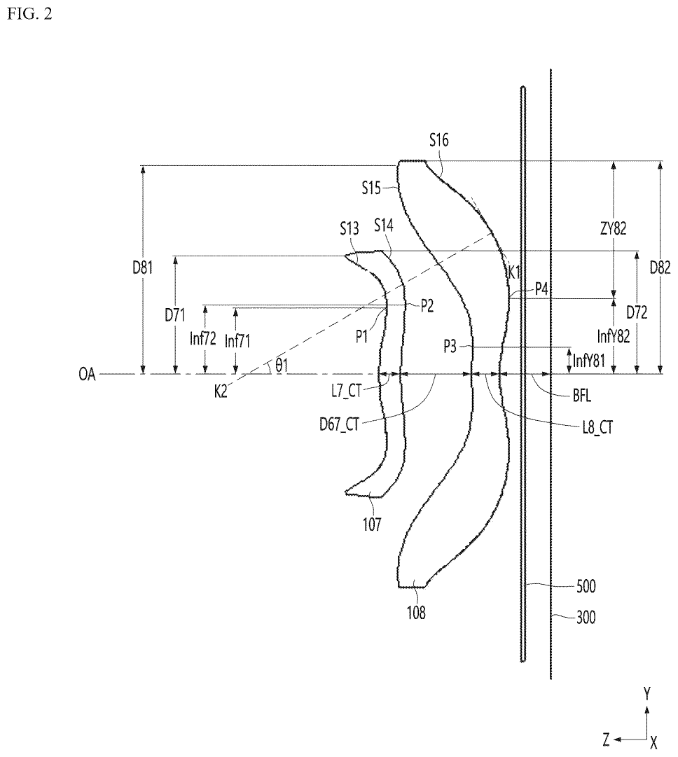

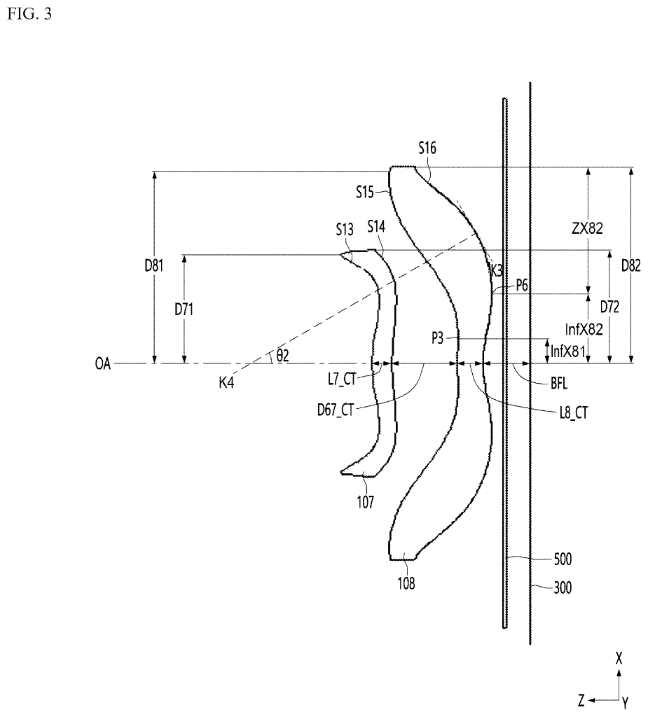

FIG. 1 is a configuration diagram of an optical system and a camera module according to an embodiment (s) of the invention, and FIG. 2 is a relationship between an image sensor, an n-th lens, and an n−1-th lens in a first direction Y of the optical system of FIG. 1, and FIG. 3 is an explanatory diagram showing the relationship between the image sensor, the n-th lens, and the n−1-th lens in the second direction X of the optical system of FIG. 1.

Referring to FIGS. 1 to 3, the optical system 1000 according to the first to third embodiments includes a plurality of lenses 100, and the plurality of lenses 100 may include first lenses 101 to eighth lens 108. The first to eighth lenses 101 to 108 may be sequentially aligned along the optical axis OA of the optical system 1000. Light corresponding to object information may pass through the first lens 101 to the eighth lens 108 and be incident on the image sensor 300.

The first lens 101 may have positive (+) refractive power on the optical axis OA. The first lens 101 may include a plastic or glass material. For example, the first lens 101 may be made of a plastic material.

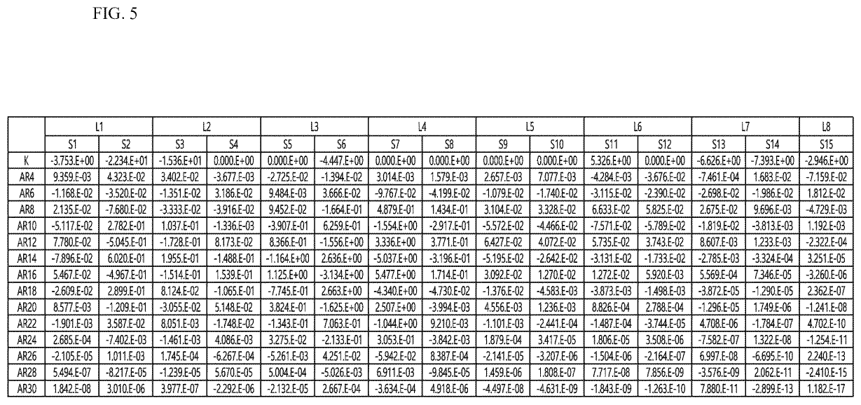

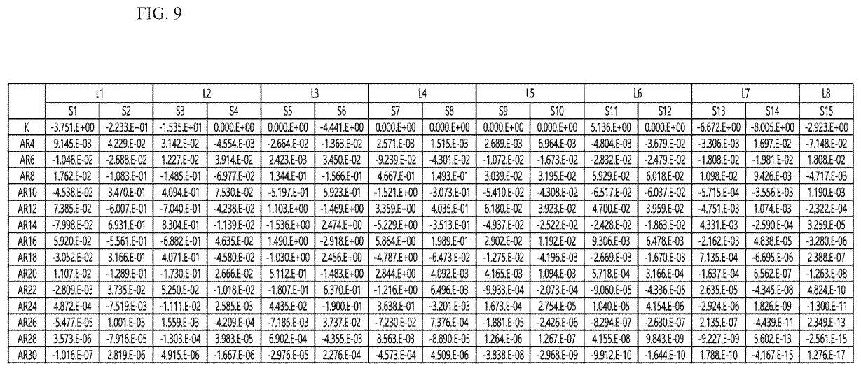

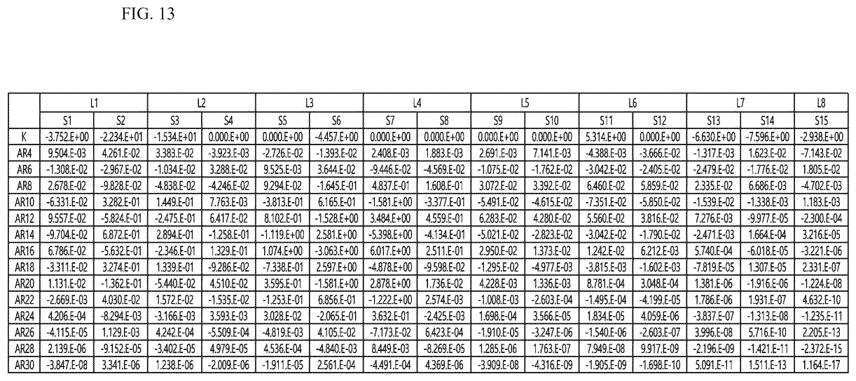

The first lens 101 may include a first surface S1 defined as an object-side surface and a second surface S2 defined as a sensor-side surface. On the optical axis OA, the first surface S1 may have a convex shape, and the second surface S2 may have a concave shape. That is, the first lens 101 may have a meniscus shape convex on the optical axis OA toward the object side. At least one of the first surface S1 and the second surface S2 may be an a spherical surface. For example, both the first surface S1 and the second surface S2 may be aspherical. Aspheric coefficients of the first and second surfaces S1 and S2 are provided as shown in FIGS. 5, 9 and 13, and L1 is the first lens 101.

The second lens 102 may have positive (+) or negative (−) refractive power on the optical axis OA. The second lens 102 may have positive (+) refractive power. The second lens 102 may include a plastic or glass material. For example, the second lens 102 may be made of a plastic material.

The second lens 102 may include a third surface S3 defined as an object-side surface and a fourth surface S4 defined as a sensor-side surface. On the optical axis OA, the third surface S3 may have a concave shape, and the fourth surface S4 may have a convex shape. That is, the second lens 102 may have a convex shape on both sides of the optical axis OA. Alternatively, On the optical axis OA, the third surface S3 may have a convex shape, and the fourth surface S4 may have a concave shape. At least one of the third and fourth surfaces S3 and S4 may be an aspherical surface. For example, both the third surface S3 and the fourth surface S4 may be aspheric surfaces. Aspheric coefficients of the third and fourth surfaces S3 and S4 are provided as shown in FIGS. 5, 9 and 13, and L2 is the second lens 102.

The third lens 103 may have positive (+) or negative (−) refractive power on the optical axis OA, and may preferably have positive (+) refractive power. The third lens 103 may include a plastic or glass material. For example, the third lens 103 may be made of a plastic material.

The third lens 103 may include a fifth surface S5 defined as an object-side surface and a sixth surface S6 defined as a sensor-side surface. On the optical axis OA, the fifth surface S5 may have a convex shape, and the sixth surface S6 may have a concave shape. That is, the third lens 103 may have a meniscus shape convex on the optical axis OA toward the object side. Alternatively, on the optical axis OA, the fifth surface S5 may have a convex shape, and the sixth surface S6 may have a convex shape. At least one of the fifth surface S5 and the sixth surface S6 may be an aspheric surface. For example, both the fifth surface S5 and the sixth surface S6 may be aspheric surfaces. Aspheric coefficients of the fifth and sixth surfaces S5 and S6 are provided as shown in FIGS. 5, 9 and 13, and L3 is the third lens 103.

The first lens group G1 may include the first to third lenses 101, 102, and 103. In the thicknesses on the optical axis OA of the first to third lenses 101, 102, and 103, that is, the center thickness of the lens, the second lens 102 may have the thickest thickness and the third lens 103 may have the thinnest thickness. Accordingly, the optical system 1000 may control incident light and may have improved aberration characteristics and resolution.

In an average of effective diameters (CA: clear aperture) among the first to third lenses 101, 102, and 103, the third lens 103 may have the smallest, and the first lens 101 may have the largest. In detail, among the first to third lenses 101, 102, and 103, the effective radius D11 of the first surface S1 may be the largest, and the effective radius of the sixth surface S6 of the third lens 103 may be the smallest. Also, the effective diameter of the second lens 102 may be smaller than that of the first lens 101 and larger than the effective diameter of the third lens 103. The effective diameter of the third lens 103 may be the smallest among the lenses of the optical system 1000. The size of the effective diameter is an average value of the effective diameter of the object-side surface and the effective diameter of the sensor-side surface of each lens. Accordingly, the optical system 1000 may have improved chromatic aberration control characteristics, and may improve vignetting characteristics of the optical system 1000 by controlling incident light.

The refractive index of the third lens 103 may be greater than the refractive index of at least one or all of the first and second lenses 101 and 102. The refractive index of the third lens 103 may be greater than 1.6, for example, 1.65 or greater, and the refractive index of the first and second lenses 101 and 102 may be less than 1.6. The third lens 103 may have an Abbe number smaller than the Abbe numbers of at least one or both of the first and second lenses 101 and 102. For example, the Abbe number of the third lens 103 may be smaller than the Abbe numbers of the first and second lenses 101 and 102 with a difference of 20 or more. In detail, the Abbe number of the first and second lenses 101 and 102 may be 30 or more greater than the Abbe number of the third lens 103. Accordingly, the optical system 1000 may have improved chromatic aberration control characteristics.

When the curvature radius in the optical axis OA is expressed as an absolute value, the curvature radius of the fourth surface S4 of the second lens 102 may be the largest among the first to third lenses 101, 102, and 103. The curvature radius of the second surface S2 of the first lens 101 may be the smallest. In the first lens group G1, a difference between a lens surface having a maximum curvature radius and a lens surface having a minimum curvature radius may be 50 times or more.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be made of a plastic material.

The fourth lens 104 may include a seventh surface S7 defined as an object-side surface and an eighth surface S8 defined as a sensor-side surface. In the optical axis OA, the seventh surface S7 may have a concave shape, and the eighth surface S8 may have a convex shape. That is, the fourth lens 104 may have a meniscus shape convex on the optical axis OA toward the sensor side. Alternatively, the seventh surface S7 may have a convex shape on the optical axis OA, and the eighth surface S8 may have a convex shape on the optical axis OA. That is, the fourth lens 104 may have a convex shape on both sides of the optical axis OA. Alternatively, the seventh surface S7 may have a convex shape on the optical axis OA, and the eighth surface S8 may have a concave shape on the optical axis OA. That is, the fourth lens 104 may have a meniscus shape convex on the optical axis OA toward the object side. Alternatively, the seventh surface S7 may have a concave shape on the optical axis OA, and the eighth surface S8 may have a concave shape on the optical axis OA. That is, the fourth lens 104 may have a concave shape on both sides of the optical axis OA.

At least one of the seventh surface S7 and the eighth surface S8 may be an aspherical surface. For example, both the seventh surface S7 and the eighth surface S8 may be aspheric surfaces. Aspheric coefficients of the seventh and eighth surfaces S7 and S8 are provided as shown in FIGS. 5, 9 and 13, and L4 is the fourth lens 104.

The refractive index of the fourth lens 104 may be smaller than the refractive index of the third lens 103. The Abbe number of the fourth lens 104 may be larger than the Abbe number of the third lens 103 and smaller than the Abbe number of the first lens 101. Accordingly, the optical system 1000 may have improved chromatic aberration control characteristics.

The fifth lens 105 may have positive (+) or negative (−) refractive power on the optical axis OA. The fifth lens 105 may have positive (+) refractive power. The fifth lens 105 may include a plastic or glass material. For example, the fifth lens 105 may be made of a plastic material. The focal length of the fifth lens 105 may be greater than that of the fourth lens 104.

The fifth lens 105 may include a ninth surface S9 defined as an object-side surface and a tenth surface S10 defined as a sensor-side surface. The ninth surface S9 may have a concave shape on the optical axis OA, and the tenth surface S10 may have a convex shape on the optical axis OA. That is, the fifth lens 105 may have a meniscus shape convex on the optical axis OA toward the sensor. The ninth and tenth surfaces S9 and S10 of the fifth lens 105 may be provided from the optical axis OA to the end of the effective region without a critical point. When expressed as an absolute value, the curvature radius of the tenth surface S10 of the fifth lens 105 may be the largest in the optical system 1000. In addition, the average of the radii of curvature of the ninth and tenth surfaces S9 and S10 of the fifth lens 105 is smaller than the curvature radius of the twelfth surface S12 of the sixth lens 106 when expressed as an absolute value and may be greater than 120 mm.

At least one of the ninth surface S9 and the tenth surface S10 may be an aspherical surface. For example, both the ninth surface S9 and the tenth surface S10 may be aspheric surfaces. Aspheric coefficients of the ninth and tenth surfaces S9 and S10 are provided as shown in FIGS. 5, 9 and 13, and L5 is the fifth lens 105.

The sixth lens 106 may have positive (+) or negative (−) refractive power on the optical axis OA. The sixth lens 106 may have negative (−) refractive power. The sixth lens 106 may include a plastic or glass material. For example, the sixth lens 106 may be made of a plastic material.

The sixth lens 106 may include an eleventh surface S11 defined as an object-side surface and a twelfth surface S12 defined as a sensor-side surface. The eleventh surface S11 may have a concave shape on the optical axis OA, and the twelfth surface S12 may have a concave shape on the optical axis OA. That is, the sixth lens 106 may have a concave shape on both sides of the optical axis OA. Alternatively, the eleventh surface S11 may have a concave shape on the optical axis OA, and the twelfth surface S12 may have a convex shape on the optical axis OA. That is, the sixth lens 106 may have a meniscus shape convex toward the sensor side. When the curvature radius in the optical axis OA is expressed as an absolute value, the curvature radius of the twelfth surface S12 may be 15 times or more than the curvature radius of the eleventh surface S11. The refractive index of the sixth lens 106 may be 1.6 or more, for example, 1.65 or more, and may be greater than the refractive indices of the fourth, fifth, seventh, and eighth lenses 104, 105, 107, and 108.

From the optical axis OA to the end of the effective radius, the eleventh surface S11 may be provided without a critical point, and the twelfth surface S12 may have a critical point. At least one of the eleventh surface S11 and the twelfth surface S12 may be an aspheric surface. For example, both the eleventh surface S11 and the twelfth surface S12 may be aspherical surfaces. Aspheric coefficients of the eleventh and twelfth surfaces S11 and S12 are provided as shown in FIGS. 5, 9 and 13, and L6 is the sixth lens 106.

The seventh lens 107 may have positive (+) or negative (−) refractive power on the optical axis OA. The seventh lens 107 may have positive (+) refractive power. The seventh lens 107 may include a plastic or glass material. For example, the seventh lens 107 may be made of a plastic material.

The seventh lens 107 may include a thirteenth surface S13 defined as an object-side surface and a fourteenth surface S14 defined as a sensor-side surface. The thirteenth surface S13 may have a convex shape on the optical axis OA, and the fourteenth surface S14 may have a concave shape on the optical axis OA. That is, the seventh lens 107 may have a meniscus shape convex on the optical axis OA toward the object side. Alternatively, the thirteenth surface S13 may have a concave shape on the optical axis OA or the fourteenth surface S14 may have a convex shape on the optical axis OA, that is, the seventh lens 107 may have a concave or convex shape on both sides of the optical axis OA. Alternatively, the seventh lens 107 may have a meniscus shape convex toward the sensor.

As shown in FIG. 2, the thirteenth surface S13 and the fourteenth surface S14 of the seventh lens 107 may have at least one critical point from the optical axis OA to the end of the effective region. The critical point P1 of the thirteenth surface S13 may be located at a distance Inf71 of 49% or more of the effective radius D71, which is the distance from the optical axis OA to the end of the effective radius, for example, in the range of 49% to 69% or 54% to 64%. The critical point P2 of the fourteenth surface S14 may be located at a distance Inf72 of 40% or more of the effective radius D72 based on the optical axis OA, for example, in the range of 40% to 60% or in the range of 45% to 55%. The position of the critical point P2 of the fourteenth surface S14 may be farther from the optical axis OA than the critical point P1 of the thirteenth surface S13. Accordingly, the fourteenth surface S14 may diffuse the light incident through the thirteenth surface S13. The critical points P1 and P2 may refer to a point where the optical axis OA and the sign of the slope value with respect to the direction perpendicular to the optical axis OA change from positive (+) to negative (−) to positive (+), and may refer to a point where the slope value is 0. In addition, the critical point may be a point where the slope value of the tangent passing through the lens surface becomes smaller as it increases or a point where it becomes smaller and then increases. It is preferable that the positions of the critical points P1 and P2 of the seventh lens 107 are disposed at positions satisfying the aforementioned range in consideration of the optical characteristics of the optical system 1000. In detail, the position of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

At least one of the thirteenth surface S13 and the fourteenth surface S14 may be an aspheric surface. For example, both the thirteenth surface S13 and the fourteenth surface S14 may be aspheric surfaces. Aspheric coefficients of the thirteenth surface S13 and the fourteenth surface S14 are provided as shown in FIGS. 5, 9 and 13, and L7 is the seventh lens 107.

The eighth lens 108 may have negative (−) refractive power on the optical axis OA. The eighth lens 108 may include a plastic or glass material. For example, the eighth lens 108 may be made of a plastic material. The eighth lens 108 may be the closest lens to the sensor side or the last lens in the optical system 1000.

The eighth lens 108 may include a fifteenth surface S15 defined as an object-side surface and a sixteenth surface S16 defined as a sensor-side surface. The fifteenth surface S15 may have a convex shape on the optical axis OA, and the sixteenth surface S16 may have a concave shape on the optical axis OA. That is, the eighth lens 108 may have a convex shape toward the object side from the optical axis OA. Alternatively, the fifteenth surface S15 of the eighth lens 108 may have a concave shape, and the sixteenth surface S16 may have a concave or convex shape.

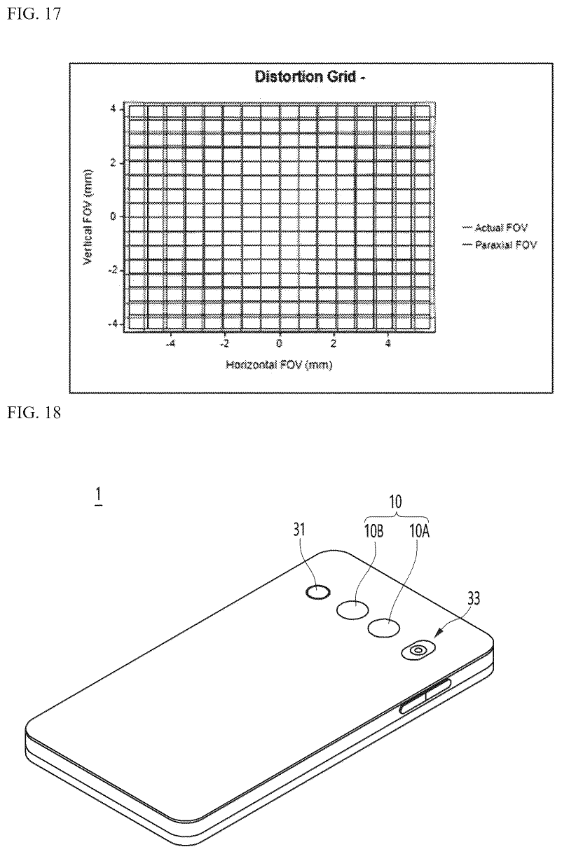

The fifteenth surface S15 may be an aspherical surface. The sixteenth surface S16 may be a freeform surface. The aspheric coefficient of the fifteenth surface S15 is provided as shown in FIGS. 5, 9 and 13, L8 is the eighth lens 108, and S15 of L8 is provided. Further, Zernike polynomial coefficients C1-C66 representing the freeform surface of the sixteenth surface S16 may be obtained according to the first to third embodiments, as shown in FIG. 17. Accordingly, the eighth lens 108 may be a freeform lens.

As shown in FIGS. 2 and 3, the eighth lens 108 may have at least one critical point between the fifteenth surface S15 and the sixteenth surface S16 extending from the optical axis OA to the end of the effective region. The critical point P3 of the fifteenth surface S15 may be located at a distance Inf81 of 45% or less of the effective radius D81, which is the distance from the optical axis OA to the end of the effective radius, for example, in the range of 10% to 45% or in the range of 10% to 40%. The critical points P4 and P6 of the sixteenth surface S16 are the first and second distances InfX82 and InfY82 in the first and second directions X and Y of 46% or less of the effective radius D82 based on the optical axis OA, for example, in the range of 26% to 46% or in the range of 31% to 41%. The positions of the critical points P4 and P6 of the fourteenth surface S16 may be farther from the optical axis OA than the critical points P3 of the fifteenth surface S15. Accordingly, the sixteenth surface S16 may diffuse the light incident through the fifteenth surface S15.

At least one of the fifteenth surface S15 and the sixteenth surface S16 of the eighth lens 108 may be provided as a freeform surface. For example, the sixteenth surface S16 of the eighth lens 108 is a freeform surface and has a symmetrical shape (+X, −X) in the first direction X orthogonal to the optical axis OA based on the optical axis OA, and may have a symmetrical shape (+Y, −Y) in the second direction Y orthogonal to the optical axis OA. That is, as shown in FIGS. 2 and 3, the lens surfaces in the +Y and −Y directions are symmetrical on both sides of the second direction Y with respect to the X-Z plane or the optical axis OA, and the lens surfaces of +X and −X directions are symmetrical on both sides of the first direction X based on the Y-Z plane or the optical axis OA. Here, the Z-axis direction is the optical axis direction. The first direction X and the second direction Y may be orthogonal to each other and may have an asymmetrical shape with respect to the optical axis OA. Effective radii D82 of the sixteenth surface S16 in the first and second directions X and Y may be the same or different. When there is a difference between the effective radii D82 of the sixteenth surface S16 in the first and second directions X and Y, it may be the same as the difference between the critical points P4 and P6. The first distance InfX82 is a distance from the optical axis OA of the sixteenth surface S16 to the critical point P4 in the first direction X, and the second distance InfY82 is a distance from the optical axis OA to the critical point P6 in the second direction Y, and may satisfy the following condition: InfX82>InfY82. The difference between the first and second distances InfX82 and InfY82 may be 0.5% or less, for example, in the range of 0.01% to 0.5%. The first and second distances InfX82 and InfY82 may be disposed within a range of 1.5 mm or more, for example, 1.5 mm to 2.1 mm, from the optical axis OA. It is preferable that the positions of the critical points P3, P4, and P6 of the eighth lens 108 are disposed at positions satisfying the aforementioned range in consideration of the optical characteristics of the optical system 1000. In detail, the location of the critical point preferably satisfies the range described above for controlling optical characteristics such as chromatic aberration, distortion characteristics, aberration characteristics, and resolving power of the optical system 1000. Accordingly, the path of light emitted to the image sensor 300 through the lens may be effectively controlled. Therefore, the optical system 1000 according to the embodiment may have improved optical characteristics even in the center and periphery portions of the FOV.

The sixteenth surface S16 of the eighth lens 108 may have different distances ZX82 and XY82 from the critical points P4 and P6 in the first and second directions X and Y to the ends of the effective diameter, for example, satisfying the condition: ZX82>ZY82, and may range from 1.5 mm to 2.2 mm.

In addition, the normal lines K2 and K4 which is a straight line perpendicular to the tangent lines K1 and K3 of the first and second directions X and Y passing through an arbitrary point on the sensor-side sixteenth surface S16 of the last lens (eighth lens 108) may have a predetermined angles θ1 and θ2 with the optical axis OA, and the angles θ1 and θ2 in the first and second directions X and Y may be different from each other, and the maximum angle may be less than 60 degrees, such as a range of 5 degrees to 59 degrees or a range of 10 degrees to 50 degrees. Accordingly, since the optical axis or paraxial region of the sixteenth surface S16 has a minimum Sag value, a slim optical system may be provided.

The second lens group G2 may include the fourth to eighth lenses 104, 105, 106, 107, and 108. Among the fourth to eighth lenses 104, 105, 106, 107, and 108, a lens having a maximum center thickness may be greater than a center distance between the third and fourth lenses 103 and 104. In the second lens group G2, the lens having the maximum center thickness may be the eighth lens 105, and the lens having the minimum center thickness may be the fifth lens 105. Accordingly, the optical system 1000 may control incident light and may have improved aberration characteristics and resolution.

Among the fourth to eighth lenses 104, 105, 106, 107, and 108, the fourth lens 104 may have the smallest effective diameter (CA: clear aperture) of the lenses, and the eighth lens 108 may have the largest. Specifically, in the second lens group G2, the size of the effective diameter of the seventh surface S7 of the fourth lens 104 may be the smallest, and the size of the effective diameter of the sixteenth surface S16 may be the largest. The size of the effective diameter of the sixteenth surface S16 may be the maximum effective diameter in the optical system and may be 2.2 times greater than the size of the effective diameter of the seventh surface S7. The size of the effective diameter of the eighth lens 108 is the largest, so that incident light may be effectively refracted toward the image sensor 300. Accordingly, the optical system 1000 may have improved chromatic aberration control characteristics, and may improve vignetting characteristics of the optical system 1000 by controlling incident light.

In the second lens group G2, the number of lenses having a refractive index exceeding 1.6 may be smaller than the number of lenses having a refractive index of less than 1.6. In the second lens group G2, the number of lenses having an Abbe number greater than 50 may be smaller than the number of lenses having an Abbe number less than 50.

AS shown in FIGS. 2 and 3, BFL (Back focal length) is a distance on the optical axis from the image sensor 300 to the last lens. That is, the BFL is the optical axis distance between the image sensor 300 and the sensor-side sixteenth surface S16 of the eighth lens 108. L7_CT is the center thickness or optical axis thickness of the seventh lens 107, and L7_ET is the end or edge thickness of the effective region of the seventh lens 107. L8_CT is the center thickness or optical axis thickness of the eighth lens 108. D78_CT is the optical axis distance (i.e., center distance) from the center of the sensor-side surface of the seventh lens 107 to the center of the object-side surface of the eighth lens 108. That is, the optical axis distance D78_CT from the center of the sensor-side surface of the seventh lens 107 to the center of the object-side surface of the eighth lens 108 is a distance between the fourteenth surface S14 and the fifteenth surface S15 on the optical axis OA. D78_CT may be larger than the optical axis distance between the third and fourth lenses 103 and 104. D78_CT may be greater than the sum of center thicknesses of the seventh and eighth lenses 107 and 108. D78_CT may be 1.8 times or more, for example, 1.8 times to 2.5 times the center thickness of the lens having the maximum thickness in the optical system 1000, that is, the second lens 102.

The center thickness of the second lens 102 is the largest among the lenses, and the center distance D78_CT between the seventh lens 107 and the eighth lens 108 is the maximum among the distances between the lenses. The center thickness of the third lens 103 is the smallest among the lenses, and the center distance between the second and third lenses 102 and 103 is the smallest among the distances between the lenses. The center distance between the fourth and fifth lenses 104 and 105 may be 2.5 times or less, for example, 2 times or less of the center distance between the second and third lenses 102 and 103 among the distances between the lenses.

The refractive index of the sixth lens 106 may be greater than that of the seventh and eighth lenses 107 and 108 and may exceed 1.6. The sixth lens 106 may have an Abbe number smaller than that of the seventh and eighth lenses 107 and 108. For example, the Abbe number of the sixth lens 106 may be smaller by a difference of 20 or more from the Abbe number of the seventh and eighth lenses 107 and 108. In detail, the Abbe number of the seventh and eighth lenses 107 and 108 may be 30 or more greater than the Abbe number of the sixth lens 106, for example, 50 or more. Accordingly, the optical system 1000 may have improved chromatic aberration control characteristics.

Among the lenses 101 to 108, the maximum center thickness may be 2.5 times or more, for example, 2.5 times to 5 times the minimum center thickness. The third lens 103 having the maximum center thickness may be 2.5 times or more, for example, 2.5 times to 4 times greater than the second lens 102 having the minimum center thickness. Among the plurality of lenses 100, the number of lenses having a center thickness of less than 0.5 mm may be equal to the number of lenses having a center thickness of 0.5 mm or more. Accordingly, the optical system 1000 may be provided with a structure having a slim thickness. Among the plurality of lens surfaces S1 to S16, the number of surfaces having an effective radius of less than 2 mm may be equal to or greater than the number of surfaces having an effective radius of 2 mm or more. Describing the curvature radius as an absolute value, the curvature radius of the third surface S3 of the second lens 102 among the plurality of lenses 100 may be the largest among the lens surfaces on the optical axis OA, and the curvature radius of the fifteenth surface S15 of the eighth lens 108 may be the smallest among lens surfaces on the optical axis OA.

When the focal length is described as an absolute value, the focal length of the sixth lens 106 among the plurality of lenses 100 may be the largest among the lenses, the focal length of the eighth lens 108 may be the smallest, and the maximum focal length may be more than 100 times the minimum focus distance.

The optical system 1000 according to the embodiment disclosed above may satisfy at least one or two or more of equations described below. Accordingly, the optical system 1000 according to the embodiment may have improved optical characteristics. For example, when the optical system 1000 satisfies at least one equation, the optical system 1000 may effectively control aberration characteristics such as chromatic aberration and distortion aberration, and may have good optical performance not only in the center portion of the FOV but also in the periphery portion. The optical system 1000 may have improved resolving power and may have a slimmer and more compact structure.

$$1 < L1\_CT / L3\_CT < 5 \qquad [ Equation 1 ]$$

In Equation 1, L1_CT means the thickness (mm) of the first lens 101 on the optical axis OA, and L3_CT means the thickness (mm) of the third lens 103 on the optical axis OA. When the optical system 1000 satisfies Equation 1, the optical system 1000 may improve aberration characteristics. Preferably, Equation 1 above may satisfy: 1<L1_CT/L3_CT≤3.

$$0.5 < L3\_CT / L3\_CT < 2 \qquad [ Equation 2 ]$$

In Equation 2, L3_CT means the thickness (mm) of the third lens 103 on the optical axis OA, and L4_CT means the thickness (mm) of the fourth lens 104 on the optical axis OA. When the optical system 1000 satisfies Equation 2, the optical system 1000 may have improved chromatic aberration control characteristics. Preferably, Equation 2 above may satisfy: 0.5<L3_CT/L4_CT≤1.5.

$$( L1\_CT + L3\_CT ) < L2\_CT \qquad [ Equation 2 - 1 ]$$

In Equation 2-1, L2_CT means the thickness of the second lens 102 on the optical axis OA, and may be greater than the sum of the center thickness L1_CT of the first lens 101 and the center thickness L3_CT of the third lens 103. When the optical system 1000 satisfies Equation 2-1, the optical system 1000 may have improved chromatic aberration control characteristics.

$$1 < L8\_CT / L7\_CT < 2 \qquad [ Equation 3 ]$$

In Equation 3, L8_CT means the thickness (mm) of the eighth lens 108 on the optical axis OA, and L7_CT means the thickness (mm) of the seventh lens 107 on the optical axis OA. In detail, when the optical system 1000 satisfies Equation 3, the optical system 1000 may have improved chromatic aberration control characteristics.

$$0.1 < L1\_CT / L8\_CT < 1 \qquad [ Equation 4 ]$$

$$1 < L2\_CT / L8\_CT < 3 \qquad [ Equation 5 ]$$

When the optical system 1000 satisfies Equations 4 and 5, the optical system 1000 may have improved chromatic aberration control characteristics. Accordingly, the thicknesses of the first, second, and eighth lenses 101, 102, and 108 may satisfy: L1_CT<L8_CT<L2_CT.

$$0.1 < D12\_CT / D78\_CT < 1 \qquad [ Equation 6 ]$$

In Equation 11, D12_CT means an optical axis distance (mm) between the first lens 101 and the second lens 102. In detail, the D12_CT means the distance (mm) of the second surface S2 of the first lens 101 and the third surface S3 of the second lens 102 along the optical axis OA. The D78_CT means an optical axis distance (mm) between the center of the fourteenth surface S14 of the seventh lens 107 and the center of the fifteenth surface S15 of the eighth lens 108. When the optical system 1000 according to the embodiment satisfies Equation 6, the optical system 1000 may improve aberration characteristics, and control the size of the optical system 1000, for example, TTL (total track length) reduction. Preferably, Equation 6 may satisfy: 0.01<D12_CT/D78_CT≤0.5.

$$1 < G1\_TD / D34\_CT < 5 \qquad [ Equation 7 ]$$

In Equation 7, G1_TD means the distance (mm) in the optical axis between the first object-side surface S1 of the first lens 101 and the sensor-side sixth surface S6 of the third lens 103. D34_CT means an optical axis distance (mm) between the third lens 103 and the fourth lens 104. In detail, the D34_CT means the distance (mm) of the sixth surface S6 of the third lens 103 and the seventh surface S7 of the fourth lens 104 in the optical axis OA. When the optical system 1000 satisfies Equation 7, the thickness of the first lens group G1 and the optical axis distance between the second lens group G2 may be set, and the aberration characteristics of the optical system 1000 may be improved, and TTL (total track length) reduction may be controlled.

$$1 < G2\_TD / D78\_CT < 5 \qquad [ Equation 8 ]$$

In Equation 8, G2_TD means the distance (mm) in the optical axis between the object-side seventh surface S7 of the fourth lens 104 and the sensor-side sixteenth surface S16 of the eighth lens 108. D78_CT means an optical axis distance (mm) between the seventh lens 107 and the eighth lens 108. In detail. D78_CT means the distance (mm) of the fourteenth surface S14 of the seventh lens 107 and the fifteenth surface S15 of the eighth lens 108 in the optical axis OA. Equation 8 may set the total optical axis distance of the second lens group G2 and the largest interval within the second lens group G2. When the optical system 1000 according to the embodiment satisfies Equation 8, the optical system IO may improve aberration characteristics, and control the size of the optical system 1000, for example, TTL reduction. Preferably, the value of Equation 8 may be 2 or more and 4 or less.

Also, Equation 7 or/and 8 may further satisfy at least one of Equations 8-1 to 8-7 below.

$$G1\_TD < G2\_TD \qquad [ Equation 8 - 1 ]$$

$$D34\_CT < D78\_CT \qquad [ Equation 8 - 2 ]$$

$$G1\_TD \leq D78\_CT \qquad [ Equation 8 - 3 ]$$

$$1 < G2\_TD / G1\_TD < 4 \qquad [ Equation 8 - 4 ]$$

$$3 < nL / D78\_CT < 5.5 \qquad [ Equation 8 - 5 ]$$

Here, nL is the number of lenses in the optical system 1000, and may be in the range of 7 to 9 or 8, for example.

$$1 < nL / G2\_TD < 3 \qquad [ Equation 8 - 6 ]$$

$$3 < nL / G1\_TD < 3 \qquad [ Equation 8 - 7 ]$$

$$0 < ( L7\_CT + L8\_CT ) / D78\_CT < 1 \qquad [ Equation 9 ]$$

In Equation 9, the sum of the center thickness L7_CT of the seventh lens 107 and the center thickness L8_CT of the eighth lens 108 may be smaller than the optical axis distance D78_CT between the seventh and eighth lenses 107 and 108. When the optical system 1000 satisfies Equation 9, the optical system 1000 may improve aberration characteristics and slimly control TTL.

$$0 < L 1 R 1 / L 8 R 2 < 5 \qquad [ Equation 10 ]$$

In Equation 10, L1R1 means the radius (mm) of curvature of the optical axis OA of the first surface S1 of the first lens 101, and L8R2 means the radius (mm) of curvature of the sixteenth surface S16 of the eighth lens 108 on the optical axis OA. When the optical system 1000 according to the embodiment satisfies Equation 10, it is possible to improve optical performance by controlling the shape and refractive power of the first and eighth lenses.

Equation 10 may further include at least one of Equations 10-1 to 10-3 for the surface shape, refractive power, and optical performance of the lens of the optical system 1000.

$$100 < \vert L 5 R 1 / L 8 R 2 \vert < 300 \qquad [ Equation 10 - 1 ]$$

In Equation 10-1, L5R1 means the curvature radius (mm) of the ninth surface S9 of the fifth lens 105 on the optical axis OA. When Equation 10-1 is satisfied, the shape and refractive power of the fifth and eighth lenses may be controlled, and the optical performance of the second lens group G2 may be improved.

$$1 < \vert L 5 R 1 / L 6 R 2 \vert < 10 \qquad [ Equation 10 - 2 ]$$

In Equation 10-2, L6R2 means the curvature radius (mm) of the twelfth surface S12 of the sixth lens 106 on the optical axis OA. When Equation 10-2 is satisfied, the shape and refractive power of the fifth and sixth lenses may be controlled.

$$1 < \vert L 5 R 1 / L 2 R 2 \vert < 10 \qquad [ Equation 10 - 3 ]$$

In Equation 10-2, L2R2 means the curvature radius of the fourth surface S4 of the second lens 102 on the optical axis OA. When Equation 10-2 is satisfied, the shape and refractive power of the first and fifth lenses may be controlled.

Here, the absolute curvature radius of the fourth surface S4 of the second lens 102, the ninth surface S9 of the fifth lens 105, and the twelfth surface S12 of the sixth lens 106 The value may be greater than 100, and when representing an absolute value, the following equation may satisfy: L2R2<L6R2<L5R1.

$$10 < ( \vert L 5 R 1 / L2\_CT \vert ) < 90 \qquad [ Equation 11 ]$$

In Equation 11, L5R1 means the curvature radius (mm) of the ninth surface S9 of the fifth lens 105 on the optical axis OA, and L2_CT is the thickness of the second lens 102 on the optical axis, and nL is the number of lenses of the optical system 1000. When Equation 11 is satisfied, the refractive power of the second and fifth lenses may be controlled, and optical performance of incident light may be improved.

Equation 11 may further include at least one of Equations 11-1 and 11-2 below.

$$10 < ( \vert L 5 R 1 \vert / L2\_CT ) / nL < 90 \qquad [ Equation 11 - 1 ]$$

In Equation 11-1, L_R_Max is the maximum curvature radius on the optical axis OA among the first to sixteenth surfaces 16, and L_CT_Max is the maximum optical axis thickness among the first to eighth lenses 101 to 108.

$$10 < ( \vert L\_R \_Max \vert / L\_CT \_Max ) / nL < 90 \qquad [ Equation 11 - 2 ]$$

In Equation 11-2, L_R2_Max is the maximum value of the curvature radius R2 of the sensor-side surfaces of the first to eighth lenses 101 to 108, and nL is the number of lenses in the optical system 1000.

$$11 < D6\_CT / D67\_CT < 30 \qquad [ Equation 12 ]$$

Equation 12 may set the thickness D6_CT of the sixth lens 106 in the optical axis and the distance D67_CT of the sixth and seventh lenses 106 and 107 in the optical axis. When the optical system satisfies Equation 12, the optical system 1000 may improve aberration characteristics and control the size of the optical system 1000, for example, TTL reduction.

$$0 < ( D78\_CT ) / InfX 82 < 3 \qquad [ Equation 13 ]$$

In Equation 13, D78_CT is the optical axis distance between the seventh and eighth lenses 107 and 108, and InfX82 is the straight distance (mm) from the optical axis OA to the critical point P6 in the X-axis direction located on the sensor-side surface S16 of the eighth lens 108. The critical point P6 may be a first critical point in the X-axis direction adjacent to the optical axis OA. When the optical system satisfies Equation 13, optical performance, for example, distortion aberration characteristics at the periphery portion in the X-axis direction may be improved. Preferably, the value of Equation 13 may be 0.5 or more and 2 or less.

$$0 < ( D78\_CT ) / InfY 82 < 3 \qquad [ Equation 14 ]$$

In Equation 14, InfY82 is a straight distance (mm) from the optical axis OA to the critical point P4 in the Y-axis direction located on the sensor-side surface S16 of the eighth lens 108. The critical point P4 may be a first critical point in the Y-axis direction adjacent to the optical axis OA. When the optical system satisfies Equation 14, optical performance, for example, distortion aberration characteristics at the periphery portion in the Y-axis direction may be improved. Preferably, the value of Equation 14 may be 0.5 or more and 2 or less, and may be greater than the value of Equation 13. Also, InfX82 and InfY82 may differ from each other, and the difference may be less than 0.5 mm.

$$0 < ( D78\_CT ) / Inf 82 < 3 \qquad [ Equation 15 ]$$

In Equation 15, Inf82 is an average value of the straight distance (mm) from the optical axis OA to the critical point P4 in the Y-axis direction located on the sensor-side surface S16 of the eighth lens 108 and the distance to the critical point P6 in the X-axis direction. When the optical system satisfies Equation 15, optical performance, for example, distortion aberration characteristics at the periphery portion in the X and Y axis directions may be improved.

$$1.6 < n 3 \qquad [ Equation 16 ]$$

In Equation 4, n3 means the refractive index of the third lens 103 at the d-line. When the optical system 1000 according to the embodiment satisfies Equation 16, the optical system 1000 may improve chromatic aberration characteristics.

Equation 16 may include at least one of Equations 16-1 to 16-2 below.

$$1.5 < n 1 < 1.6 \qquad [ Equation 16 - 1 ]$$

$$1.5 < n 8 < 1.6 \qquad [ Equation 16 - 2 ]$$

In Equations 16-1 and 16-2, n1 is the refractive index of the first lens 101 at the d-line, and n8 is the refractive index of the eighth lens 108 at the d-line. When the optical system 1000 according to the embodiment satisfies Equations 16-1 and 16-2, chromatic aberration characteristics may be improved.

$$1.65 < AVR ( n 3 , n 6 ) < 1.75 \qquad [ Equation 17 ]$$

In Equation 17, n6 means the refractive index at the d-line of the sixth lens 106, and AVR (n3, n6) means the average refractive index of the third and sixth lenses 103 and 106. When the optical system 1000 according to the embodiment satisfies Equation 17, the optical system 1000 may improve chromatic aberration characteristics.

$$1 < CA\_L1S1 / CA\_L3S1 < 2 \qquad [ Equation 18 ]$$

In Equation 18, CA_L1S1 means a size (mm) of the effective diameter CA (clear aperture) of the first surface S1 of the first lens 101, CA_L3S1 means a size (mm) of the effective diameter CA of the fifth surface S5 of the third lens 103. When the optical system 1000 according to the embodiment satisfies Equation 18, the optical system 1000 may control light incident to the first lens group G1 and may have improved aberration control characteristics. The value of Equation 18 may be 1.5 or less.

$$1 < CA\_L8S2 / CA\_L4S2 < 5 \qquad [ Equation 19 ]$$

In Equation 19, CA_L4S2 means the size (mm) of the effective diameter CA of the eighth surface S8 of the fourth lens 104. When the optical system 1000 according to the embodiment satisfies Equation 19, the optical system 1000 may control the path of light traveling through the second lens group G2 and may have improved aberration control characteristics. The value of Equation 19 may be 4 or less.

$$0.2 < CA\_L3S2 / CA\_L4S1 < 2 \qquad [ Equation 20 ]$$

In Equation 20, CA_L3S2 means the size (mm) of the effective diameter CA of the sixth surface S6 of the third lens 103, and CA_L4S1 means the size (mm) of the effective diameter CA of the seventh surface S7 of the fourth lens 104. When the optical system 1000 according to the embodiment satisfies Equation 18, the optical system 1000 may improve chromatic aberration, and the lengths of opposite lens surfaces of the first lens group G1 and the second lens group G2 may be set, and vignetting may be controlled for optical performance.

$$0.1 < CA\_L6S2 / CA\_L8S2 < 2 \qquad [ Equation 21 ]$$

In Equation 21, CA_L6S2 means the size (mm) of the effective diameter CA of the twelfth surface S12 of the sixth lens 106. When the optical system 1000 according to the embodiment satisfies Equation 21, the optical system 1000 may control light traveling to the sixth to eighth lenses 106, 107, and 108, and may improve aberration characteristics.

$$1 < L 7 R 1 / L7\_CT < 10 \qquad [ Equation 22 ]$$

In Equation 22, L7R1 means the curvature radius (mm) of the second surface S2 of the seventh lens 107, and L7_CT means the thickness of the seventh lens 107 on the optical axis. That is, Equation 22 may satisfy: L7R1>L7_CT, and the value of Equation 22 may be 2 or more. When the optical system 1000 according to the embodiment satisfies Equation 22, the aberration characteristics of the optical system 1000 may be improved.

$$1 < \vert L 6 R 1 / L 8 R 1 \vert < 5 \qquad [ Equation 23 ]$$

In Equation 14, L6R1 means the curvature radius (mm) of the eleventh surface S11 of the sixth lens 106, and L8R1 means the curvature radius (mm) of the fifteenth surface S15 of the eighth lens 108. When the optical system 1000 according to the embodiment satisfies Equation 23, the aberration characteristics of the optical system 1000 may be improved. The value of Equation 23 may be 4 or less.

$$0 < L\_CT \_Max / Air\_Max < 5 \qquad [ Equation 24 ]$$

In Equation 24, L_CT_Max means the thickest thickness (mm) on the optical axis OA of each of the plurality of lenses, and Air_Max means the maximum value of the optical axis distances between the plurality of lenses. When the optical system 1000 according to the embodiment satisfies Equation 24, the optical system 1000 has good optical performance at the set angle of view and focal length, and may reduce the size of the optical system 1000, for example, TTL. The value of Equation 24 may be 3 or less or 1 or less.

$$0.5 < \sum L\_CT / \sum Air\_CT < 2 \qquad [ Equation 25 ]$$

In Equation 25, ΣL_CT means the sum of the thicknesses (mm) in the optical axis OA of each of the plurality of lenses, and ΣAir_CT means the sum of distances (mm) on in the optical axis OA between two adjacent lenses in the plurality of lenses. When the optical system 1000 according to the embodiment satisfies Equation 25, the optical system 1000 has good optical performance at the set angle of view and focal length, and may reduce the size of the optical system 1000, for example, TTL.

$$10 < \sum Index < 30 \qquad [ Equation 26 ]$$

In Equation 26, ΣIndex means the sum of the refractive indices of the plurality of lenses 100 at d-line. When the optical system RXX) according to the embodiment satisfies Equation 26, the TTL of the optical system 1000 may be controlled and resolution may be improved.

Equation 26 may further satisfy Equations 26-1 and 26-2.

$$1.5 < \sum Index / nL < 1.6 \qquad [ Equation 26 - 1 ]$$

$$30 < \sum Abb / nL < 50 \qquad [ Equation 26 - 2 ]$$

ΣAbbe means the sum of Abbe numbers of each of the plurality of lenses 100, and nL is the number of lenses in the optical system, and may be 8 or 7 to 9, for example.

$$10 < \sum Abb / \sum Index < 50 \qquad [ Equation 27 ]$$

In Equation 27, ΣAbbe means the sum of Abbe numbers of each of the plurality of lenses 100. When the optical system 1000 according to the embodiment satisfies Equation 27, the optical system 1000 may have improved aberration characteristics and resolution.

Equation 27 may further satisfy Equation 27-1.

$$20 < ( \sum Abb + \sum Index ) / nL < 50 \qquad [ Equation 27 - 1 ]$$

$$0.5 < CA\_L1S1 / CA\_min < 2 \qquad [ Equation 28 ]$$

In Equation 28, CA_L1S1 means the effective diameter (mm) of the first surface S1 of the first lens 101, and CA_Min means the smallest effective diameter (mm) among the first to sixteenth surfaces S1-S16. When the optical system 1000 according to the embodiment satisfies Equation 28, it is possible to control light incident through the first lens 101 and provide a slim optical system while maintaining optical performance.

$$1 < CA\_max / CA\_min < 5 \qquad [ Equation 29 ]$$

In Equation 29, CA_max means the largest effective diameter (mm) among the object-side and sensor-side surfaces of the plurality of lenses, and means the largest effective diameter (mm) among the first to sixteenth surfaces S1-S16. When the optical system 1000 according to the embodiment satisfies Equation 29, the optical system 1000 may provide a slim and compact optical system while maintaining optical performance. The effective diameter of the sixteenth surface S16 may have a maximum effective diameter, and the effective diameter of the sixth surface S6 may have a minimum effective diameter.

Equation 29 may include at least one of Equations 29-1 to 29-4.

$$1 < CA\_L8 / CA\_L3 < 5 \qquad [ Equation 29 - 1 ]$$

$$1 < CA\_L8 / CA\_L4 < 5 \qquad [ Equation 29 - 2 ]$$

$$2 < CA\_L8 / CA\_L2 < 4 \qquad [ Equation 29 - 3 ]$$

$$CA\_L3 < CA\_L4 < CA\_L2 < CA\_L5 \qquad [ Equation 29 - 4 ]$$

Here, CA_L2, CA_L3, CA_L4, CA_L5, and CA_L8 are average values of the effective diameters of the object-side surface and the sensor-side surface of each lens. When the optical system satisfies Equations 29-1 to 29-4, the optical system 1000 may provide a slim and compact optical system while maintaining optical performance.

$$1 < CA\_max / CA\_AVR < 3 \qquad [ Equation 30 ]$$

In Equation 30, CA_max means the largest effective diameter (mm) among the object-side and sensor-side surfaces of the plurality of lenses, and CA_AVR means the average of the effective diameters of the object-side and sensor-side surfaces of the plurality of lenses. When the optical system 1000 according to the embodiment satisfies Equation 30, a slim and compact optical system may be provided.

$$0.1 < CA\_min / CA\_AVR < 1 \qquad [ Equation 31 ]$$

In Equation 31, CA_min means the smallest effective diameter (mm) among the object-side and sensor-side surfaces of the plurality of lenses. When the optical system 1000 according to the embodiment satisfies Equation 31, a slim and compact optical system may be provided.

$$0.1 < CA\_max / ( 2 * ImgH ) < 1 \qquad [ Equation 32 ]$$

In Equation 32, CA_max means the largest effective diameter among the object-side and sensor-side surfaces of the plurality of lenses, and ImgH means a distance (mm) from the center (0.0F) of the image sensor 300 overlapping the optical axis OA to the diagonal end. That is, the ImgH means ½ of the maximum diagonal length (mm) of the effective region of the image sensor 300. When the optical system 1000 according to the embodiment satisfies Equation 32, the optical system 1000 has good optical performance in the center and periphery of the FOV, and may provide a slim and compact optical system. The symbol * indicates multiplication.

Equation 32 may include Equation 32-2 below.

$$0.5 < ImgH / nL < 2 \qquad [ Equation 32 - 1 ]$$

$$0.5 < TTL / nL < 2 \qquad [ Equation 32 - 1 ]$$

nL is the number of lenses in the optical system, for example, 7 to 9, preferably 8, and TTL is means the distance (mm) in the optical axis OA from the apex of the first surface S1 of the first lens 101 to the image surface of the image sensor 300.

$$0.5 < TD / CA\_max < 1.5 \qquad [ Equation 33 ]$$

In Equation 39, TD is the optical axis distance (mm) from the object-side surface of the first lens 101 to the n-th lens, that is, the sensor-side surface of the eighth lens group 108. For example, it is the distance from the first surface S1 to the sixteenth surface S16 on the optical axis OA. When the optical system 1000 according to the embodiment satisfies Equation 33, a slim and compact optical system may be provided.

$$0 < F / L 8 R 2 < 10 \qquad [ Equation 34 ]$$

In Equation 34, F means the total focal length (mm) of the optical system 1000, and L8R2 means the curvature radius (mm) of the sixteenth surface S16 of the eighth lens 108 having a freeform surface. When the optical system 1000 according to the embodiment satisfies Equation 34, the optical system 1000 may reduce the size of the optical system 1000, for example, TTL.

$$1 < F / L 1 R 1 < 10 \qquad [ Equation 35 ]$$

In Equation 35, L1R1 means the curvature radius (mm) of the first surface S1 of the first lens 101. When the optical system 1000 according to the embodiment satisfies Equation 35, the size of the optical system 1000 may be reduced, for example, TTL may be reduced. The value of Equation 35 may be 5 or less, for example, 3 or less.

$$0 < EPD / L 8 R 2 < 10 \qquad [ Equation 36 ]$$

In Equation 36, EPD means the size (mm) of the entrance pupil of the optical system 1000, and L8R2 means the curvature radius (mm) of the sixteenth surface S14 of the eighth lens 108 having a freeform surface. When the optical system 1000 according to the embodiment satisfies Equation 36, the optical system 1000 may control overall brightness and may have good optical performance in the center and periphery portions of the FOV. The value of Equation 36 may be 5 or less, for example, 3 or less.

$$0.5 < EPD / L 1 R 1 < 8 \qquad [ Equation 37 ]$$

Equation 37 means the relationship between the size of the entrance pupil (EPD) of the optical system and the curvature radius of the first surface S1 of the first lens 101, and may control incident light. The value of Equation 37 may be 5 or less, for example, 3 or less.

$$- 3 < F 1 / F 3 < 0 \qquad [ Equation 38 ]$$

In Equation 38, F1 means the focal length (mm) of the first lens 101, and F3 means the focal length (mm) of the third lens 103. When the optical system 1000 according to the embodiment satisfies Equation 38, it may have appropriate refractive power for controlling light paths traveling through the first lens 101 and the third lens 103, and may improve resolving power.

$$1 < F 13 / F < 5 \qquad [ Equation 39 ]$$

In Equation 39, F13 means the composite focal length (mm) of the first to third lenses, and F means the effective focal length (mm) in two directions X and Y orthogonal to the optical axis OA in the optical system 1000. That is, the effective focal length Fx in the X direction and the effective focal length Fy in the Y direction are different from each other, and their average may be defined as F. Equation 39 establishes a relationship between the focal length of the first lens group G1 and the total effective focal length. When the optical system 1000 according to the embodiment satisfies Equation 39, the optical system 1000 may control TTL of the optical system 1000.

$$0 < \vert F 48 / F 13 \vert < 10 \qquad [ Equation 40 ]$$

In Equation 40, F13 means the composite focal length (mm) of the first to third lenses, and F48 means the composite focal length (mm) of the fourth to eighth lenses. Equation 40 establishes a relationship between the focal length of the first lens group G1 and the focal length of the second lens group G2. In an embodiment, the composite focal length of the first to third lenses may have a positive (+) value, and the composite focal length of the fourth to eighth lenses may have a negative (−) value. When the optical system 1000 according to the embodiment satisfies Equation 40, the optical system 1000 may improve aberration characteristics such as chromatic aberration and distortion aberration. The value of Equation 40 may be 8 or less, for example, 5 or less.

At least one of Equations 39 and 40 may include Equations 40-1 to 40-4.

$$- 10 < F 48 / F < 0 \qquad [ Equation 40 - 1 ]$$

$$0 < F / nL < 2 \qquad [ Equation 40 - 2 ]$$

$$1 < ( F 13 + \vert F 48 \vert + F ) / nL < 5 \qquad [ Equation 40 - 3 ]$$

$$0.5 < ( F 13 + \vert F 48 \vert ) / nL < 4 \qquad [ Equation 40 - 4 ]$$

Here, nL is the number of lenses in the optical system, and may be in the range of 7 to 9 or 8)

$$2 < TTL < 20 \qquad [ Equation 4 ]$$

In Equation 41, TTL means the distance (mm) in the optical axis OA from the center of the first surface S1 of the first lens 101 to the image surface of the image sensor 300. By setting the TTL to less than 20 in Equation 41, a slim and compact optical system may be provided.

Equation 41 may further include Equation 41-1.

$$1 \leq ( TTL + Imgh ) / nL < 5 \qquad [ Equation 41 - 1 ]$$

Here, nL is the number of lenses in the optical system, and may be 7 to 9, preferably 8.

$$2 < ImgH \qquad [ Equation 42 ]$$

Equation 42 makes the diagonal size of the image sensor 300 exceed 4 mm, thereby providing an optical system with high resolution.

$$BFL < 2.5 \qquad [ Equation 43 ]$$

Equation 43 makes the BFL (Back focal length) less than 2.5 mm, thereby securing the installation space of the filter 500, and the assembly of the components through the distance (mm) between the image sensor 300 and the last lens and improve coupling reliability. That is, when the sensor-side surface of the last lens does not have a critical point, the BFL value may be set to less than 2.5 mm, for example, 2 mm or less.

$$2 < F < 20 \qquad [ Equation 44 ]$$

In Equation 44, the total focal length (F) may be set according to the optical system.

$$FOV < 120 \qquad [ Equation 45 ]$$

In Equation 45, FOV means a degree of view of the optical system 1000, and an optical system of less than 120 degrees may be provided. The FOV may be 100 degrees or less.

$$0.5 < TTL / CA\_max < 2 \qquad [ Equation 46 ]$$

In Equation 46, CA_max means the largest effective diameter (mm) among the object-side and sensor-side surfaces of the plurality of lenses, and TTL means the distance (mm) in the optical axis OA from an apex of the first surface S1 of the first lens 101 from the image surface of the image sensor 300. Equation 46 establishes a relationship between the total optical axis length and the maximum effective diameter of the optical system, thereby providing a slim and compact optical system.

Equation 46 may further include Equation 46-1. Here, nL is the number of lenses in the optical system, and may be 7 to 9, preferably 8.

$$0 < ( TTL / CA\_max ) / nL < 0.2 \qquad [ Equation 46 - 1 ]$$

$$0.4 < TTL / ( 2 * ImgH ) < 0.7 \qquad [ Equation 47 ]$$

Equation 47 may set the total optical axis length (TTL) of the optical system and the diagonal length (2*Imgh) of the image sensor 300. When the optical system 1000 according to the embodiment satisfies Equation 47, the optical system 1000 secures a BFL (Back focal length) for applying a relatively large image sensor 300, for example, a large image sensor 300 around 1 inch, and may have a smaller TTL, thereby realizing high image quality and having a slim structure.

Equation 47 may further include Equation 47-1. Here, nL is the number of lenses in the optical system, and may be 7 to 9, preferably 8.

$$0 < ( TTL / ( 2 * ImgH ) ) / nL < 0.2 \qquad [ Equation 47 - 1 ]$$

$$0.01 < BFL / ImgH < 0.5 \qquad [ Equation 48 ]$$

Equation 48 may set the distance between the optical axis between the image sensor 300 and the last lens and the length in the diagonal direction from the optical axis of the image sensor 300. When the optical system 1000 according to the embodiment satisfies Equation 48, the optical system 1000 may secure BFL for applying a relatively large image sensor 300, for example, a large image sensor 300 around 1 inch, and the distance between the last lens and the image sensor 300 may be minimized, so that good optical characteristics may be obtained at the center and the periphery portions of the FOV.

Equation 48 may further include Equation 48-1. Here, nL is the number of lenses in the optical system, and may be 7 to 9, preferably 8.

$$0 < ( BFL / ImgH ) / nL < 0.1 \qquad [ Equation 48 - 1 ]$$

$$4 < TTL / BFL < 10 \qquad [ Equation 49 ]$$

Equation 49 may set (unit, mm) the total optical axis length (TTL) of the optical system and the optical axis distance (BFL) between the image sensor 300 and the last lens. In the invention, since the sensor-side surface of the last lens has no critical point, the value of Equation 55 may be 5 mm or more or 6 mm or more. When the optical system 1000 according to the embodiment satisfies Equation 49, the optical system 1000 secures the BFL and may be provided slim and compact.

Equation 49 may further include Equation 49-1. Here, nL is the number of lenses in the optical system, and may be 7 to 9, preferably 8.

$$0.3 < ( TTL / BFL ) / nL < 1 \qquad [ Equation 49 - 1 ]$$

$$0.5 < F / TTL < 1.5 \qquad [ Equation 50 ]$$

Equation 50 may set the total focal length (F) and total optical axis length (TTL) of the optical system 1000. Accordingly, a slim and compact optical system may be provided.

Equation 50 may further include Equation 50-1. Here, nL is the number of lenses in the optical system, and may be 7 to 9, preferably 8.

$$0 < ( F / TTL ) / nL < 0.3 \qquad [ Equation 50 - 1 ]$$

$$3 < F / BFL < 10 \qquad [ Equation 51 ]$$

Equation 51 may set (unit, mm) the total focal length (F) of the optical system 1000 and the optical axis distance (BFL) between the image sensor 300 and the last lens. In the invention, since the sensor-side surface of the last lens has no critical point, the BFL value is further narrowed, so the value of Equation 51 may be 5 mm or more. When the optical system 1000 according to the embodiment satisfies Equation 51, the optical system 1000 may have a set angle of view, may have an appropriate focal length, and may provide a slim and compact optical system. In addition, the optical system 1000 may minimize the distance between the last lens and the image sensor 300, so that it may have good optical characteristics in the periphery portion of the FOV.

Equation 51 may further include Equation 51-1. Here, nL is the number of lenses in the optical system, and may be 7 to 9, preferably 8.

$$0.2 < ( F / TTL ) / nL < 3 \qquad [ Equation 51 - 1 ]$$

$$0.1 < F / ImgH < 3 \qquad [ Equation 52 ]$$

Equation 52 may set the total focal length (F, mm) of the optical system 1000 and the diagonal length Imgh at the optical axis of the image sensor 300. The optical system 1000 may have improved aberration characteristics by applying a relatively large image sensor 300, for example, a large image sensor 300 of around 1 inch.

Equation 52 may further include Equation 52-1. Here, nL is the number of lenses in the optical system, and may be 7 to 9, preferably 8.

$$0 < ( F / Imgh ) / nL < 0.3 \qquad [ Equation 52 - 1 ]$$

$$1 \leq F / EPD < 5 \qquad [ Equation 53 ]$$

Equation 53 may set the total focal length (F, mm) of the optical system 1000 and the entrance pupil size. Accordingly, the overall brightness of the optical system may be controlled.

Equation 53 may further include Equation 53-1. Here, nL is the number of lenses in the optical system, and may be 7 to 9, preferably 8.

$$0.1 < ( F / EPD ) / nL < 0.4 \qquad [ Equation 53 - 1 ]$$

$$0.5 < TTL / ( D 82 \times 2 ) < 1.5 \qquad [ Equation 54 ]$$

In Equation 54, D82 is a straight distance from the optical axis OA to the effective diameter of the sixteenth surface S16 on the sensor side of the eighth lens 108, and may be defined as an effective radius. The optical system may set the length in the optical axis direction and the maximum effective diameter by Equation 54.

$$0.5 < F 2 / F < 1.5 \qquad [ Equation 55 ]$$

In Equation 55, F2 is the focal length of the second lens 102, and F is the average value of effective focal lengths in the X and Y directions of the optical system. As Equation 55 is satisfied, the optical system and the camera module may improve chromatic aberration characteristics by setting the ratio of average effective focal lengths in two directions X and Y orthogonal to the second lens and the optical axis to a set range.

Equation 55 may include at least one of Equations 55-1 to 55-7 below.

$$1.5 < F 1 / F < 3.2 \qquad [ Equation 55 - 1 ]$$

$$- 2.5 < F 3 / F < 0 \qquad [ Equation 55 - 2 ]$$

$$5.5 < F 4 / F < 7 \qquad [ Equation 55 - 3 ]$$

$$21 < F 5 / F < 31 \qquad [ Equation 55 - 4 ]$$

$$- 2.5 < F 6 / F < 0 \qquad [ Equation 55 - 5 ]$$

$$0.5 < F 7 / F < 1.9 \qquad [ Equation 55 - 6 ]$$

$$- 1.5 < F 8 / F < 0 \qquad [ Equation 55 - 7 ]$$

In Equations 55-1 to 55-7, F1, F3, F4, F5, F6, F7, and F8 are the focal lengths of the first, and second to eighth lenses, and F is the average value of the effective focal lengths in the X and Y directions of the optical system. As the optical system satisfies Equations 55 and 55-1 to 55-7, the ratio of the average effective focal length of each lens and the two directions X and Y orthogonal to the optical axis is set to a set range, and the distortion and chromatic aberration characteristics may improve

$$- 5 < F 2 / F 3 < 0 \qquad [ Equation 56 ]$$

The optical system may improve distortion and chromatic aberration characteristics by setting the ratio of the focal lengths of the second and third lenses to a set range as Equation 56 is satisfied.

$$0.8 < F 2 / F 12 < 1.8 \qquad [ Equation 57 ]$$

In Equation 57, F12 is the composite focal length of the first and second lenses. The optical system may improve the distortion and chromatic aberration characteristics of the first lens group G1 by setting the ratio of the focal lengths of the first and second lenses to a set range according to Equation 57.

$$0.5 < F 12 / F < 1.5 \qquad [ Equation 58 ]$$

As the optical system satisfies Equation 58, the ratio of the composite focal length of the first and second lenses to the average effective focal length in two directions X and Y orthogonal to the optical axis is set to a set range, and the distortion aberration and chromatic aberration characteristics may be improved

$$0 < L 2 R 1 / \vert L 2 R 2 \vert < 1 \qquad [ Equation 59 ]$$

In Equation 59, L2R1 is the curvature radius of the third object-side surface of the second lens 102, and L2R2 is the curvature radius of the fourth surface of the second lens 102 on the sensor side. The optical system may improve aberration characteristics by satisfying Equation 59.

$$0 < L 3 R 2 / \vert L 3 R 1 \vert < 1 \qquad [ Equation 60 ]$$

In Equation 60, L3R1 is the curvature radius of the object-side fifth surface of the third lens 103, and L3R2 is the curvature radius of the sensor-side sixth surface of the third lens 103. The optical system may improve aberration characteristics by satisfying Equation 60. Also, by satisfying Equations 59 and 60, it is possible to control with good optical performance at a set angle of view.

$$0.8 < n 2 / n 3 < 1.2 \qquad [ Equation 61 ]$$

In Equation 61, n2 is the refractive index of the second lens at the d-line, and n3 is the refractive index of the third lens 103 at the d-line. As Equation 61 is satisfied, the chromatic aberration characteristics of the optical system may be improved.

$$1 < L2\_CT / L3\_CT < 5 \qquad [ Equation 62 ]$$

By setting the center thickness of the second and third lenses within the above range in Equation 62, the optical system 1000 may have improved chromatic aberration control characteristics.

$$0.7 < Inf 71 / Inf 72 < 1.2 \qquad [ Equation 63 ]$$

In Equation 63, Inf71 is a straight distance from the optical axis OA to the critical point P1 (see FIG. 2) of the object-side thirteenth surface S13 of the seventh lens 107, and Inf72 is a straight distance from the optical axis OA to the critical point P2 (see FIG. 2) of the sensor-side fourteenth surface S14 of the seventh lens 107. Here, the critical points P1 and P2 are critical points closest to the optical axis OA on the thirteenth and fourteenth surfaces S13 and S14 of the seventh lens 107. By satisfying the range of Equation 63, the optical system may improve distortion aberration characteristics and provide good optical performance to the periphery portion of FOV.

$$0.7 < Inf 71 / Inf 82 < 1.2 \qquad [ Equation 64 ]$$

In Equation 64, Inf82 is the average of the straight distances from the optical axis OA to the critical points P4 and P6 (see FIGS. 2 and 3) in the X and Y directions of the sensor-side sixteenth surface S16 of the eighth lens 108. That is, Inf82 is the average value of the straight distance InfX82 from the optical axis to the critical point P6 (see FIG. 3) in the X direction of the sensor-side sixteenth surface S16 of the eighth lens 108 and the straight distance InfY82 from the optical axis to the critical point P4 (see FIG. 2) in the Y direction of the sensor-side sixteenth surface S16 of the eight lens 108. The InfX82 and InfY82 may be different from each other, and the critical points P4 and P6 are critical points closest to the optical axis OA in the X and Y directions on the sixteenth surface S16 of the eighth lens 108. By satisfying the range of Equation 64, the optical system may improve distortion aberration characteristics and provide good optical performance to the periphery portion of the field of view.

$$0.3 < Inf 71 / D 71 < 1. \qquad [ Equation 65 ]$$

In Equation 65, D71 is a straight distance from the optical axis OA to the effective diameter of the object-side thirteenth surface S13 of the seventh lens 107. By satisfying the range of Equation 65, the optical system may refract light incident through the seventh and eighth lenses 107 and 108 to the periphery portion, improve distortion aberration characteristics, and may provide good optical performance for the periphery portion of the FOV.

$$0.3 < Inf 72 / D 72 < 1. \qquad [ Equation 66 ]$$

In Equation 66, D72 is a straight distance from the optical axis OA to the effective diameter of the sensor-side fourteenth surface S14 of the seventh lens 107. By satisfying the range of Equation 66, the optical system may refract light incident through the seventh and eighth lenses 107 and 108 to the periphery portion, improve distortion aberration characteristics, and may provide good optical performance for the periphery portion of FOV.

$$0.2 < Inf 82 / D 82 < 0.8 \qquad [ Equation 67 ]$$

In Equation 67, D82 is a straight distance from the optical axis OA to the effective diameter of the sixteenth surface S16 on the sensor side of the eighth lens 108. By satisfying the range of Equation 67, the optical system may refract light passing through the eighth lens 108 to the periphery portion, improve distortion aberration characteristics, and may provide good optical performance for the periphery portion of FOV. The value of Equation 67 may be 0.6 or less, for example, 0.5 or less.

$$- 0.1 < FX - FY < 0.1 \qquad [ Equation 68 ]$$

In Equation 68, FX is the effective focal length in the X direction, and FY is the effective focal length in the Y direction. That is, the effective focal lengths FX and FY of two directions X and Y orthogonal to the optical axis OA may be different from each other. By satisfying Equation 68, the optical system may have good optical performance at the set FOV and focal length. Here, FX>O and FY>0.

$$- 0.1 < InfX 82 - InfY 82 < 0.1 \qquad [ Equation 69 ]$$

In Equation 69, InfX82 is a straight distance from the optical axis to the critical point P6 (see FIG. 3) in the X direction of the sensor-side sixteenth surface S16 of the eighth lens 108 and InfY82 is a straight distance from the optical axis to the critical point P4 (see FIG. 2) in the Y direction of the sensor-side sixteenth surface S16 of the eight lens 108. The InfX82 and InfY82 may be different from each other. By satisfying the range of Equation 69, the optical system may improve distortion aberration characteristics and provide good optical performance to the periphery portion of FOV. Here, InfX82>O and InfY82>0.

$$- 0.5 < ZX 82 - ZY 82 < 0.5 \qquad [ Equation 70 ]$$

In Equation 70, ZX82 is the straight distance (mm) from the critical point P6 (see FIG. 3) in the X direction of the sensor-side sixteenth surface S16 of the eighth lens 108 to the end of the effective region, and ZY82 is the straight distance (mm) from the critical point P4 (see FIG. 2) in the Y direction of the sensor-side sixteenth surface S16 to the end of the effective region. The ZX82 and ZY82 may be different from each other. By satisfying the range of Equation 70, the optical system may improve distortion aberration characteristics and provide good optical performance to the periphery portion of FOV.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 71 ]$$

In Equation 71, Z is a Sag value, and may mean a distance in the optical axis direction from an arbitrary position on the aspherical surface to the apex of the aspheric surface. Y may mean a distance in a direction perpendicular to the optical axis from an arbitrary position on the aspheric surface to the optical axis, c may mean the curvature of the lens, and K may mean the conic constant. Also, A, B, C, D, E, and F may mean aspheric constants. In the practice of the invention, aspheric surfaces may be provided from the first surface S1 to the fifteenth surface S15.

$$z = \frac{{cr}^{2}}{1 + \sqrt{1 - ( 1 + k ) {c}^{2} {r}^{2}}} + {\sum }_{j = 2}^{66} {C}_{j} {x}^{m} {y}^{n} \qquad [ Equation 72 ]$$

$$j = \frac{{( m + n )}^{2} + m + 3 n}{2} + 1$$

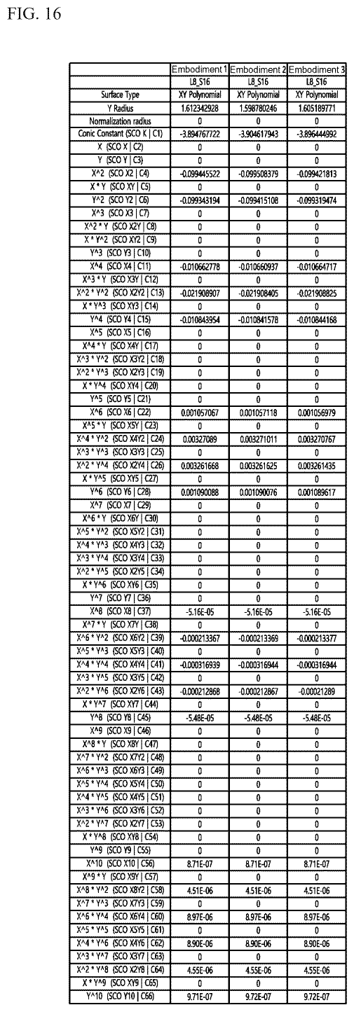

In Equation 72, Z is the Sag value of the sixteenth surface S16 and may mean a distance on the optical axis direction from an arbitrary position on the freeform surface to the apex of the free sphere surface. C is the curvature value of the sixteenth surface S16 of the eighth lens 108, r is the effective diameter value of the sixteenth surface S16, k is the conic constant, Cj is the Zernike function at the j order, among x and y polynomial coefficients, only the coefficients (m, n) of x and y to the 0, 2, 4, 6, 8, 10th power may be used, and x^{m}y^{m} is the Zernike basis (basis) in the j degree in the x and y directions. FIG. 16 shows Zernike coefficients of the sixteenth surface, which is a freeform surface according to the first, second, and third embodiments, calculated by the above equation.

The optical system 1000 according to the embodiment may satisfy at least one or two or more of Equations 1 to 70. In this case, the optical system 1000 may have improved optical characteristics. In detail, when the optical system 1000 satisfies at least one or two or more of Equations 1 to 70, the optical system 1000 has improved resolution and may improve aberration and distortion characteristics. In addition, the optical system 1000 may secure a BFL (Back focal length) for applying the large-size image sensor 300, and may minimize the distance between the last lens and the image sensor 300, so it may have good optical performance in the center and periphery portions of the FOV. In addition, when the optical system 1000 satisfies at least one of Equations 1 to 70, it may include a relatively large image sensor 300, have a relatively small TTL value, and be slimmer, and provide a compact optical system and a camera module having the same.

In the optical system 1000 according to the embodiment, the distance between the plurality of lenses 100 may have a value set according to the region.

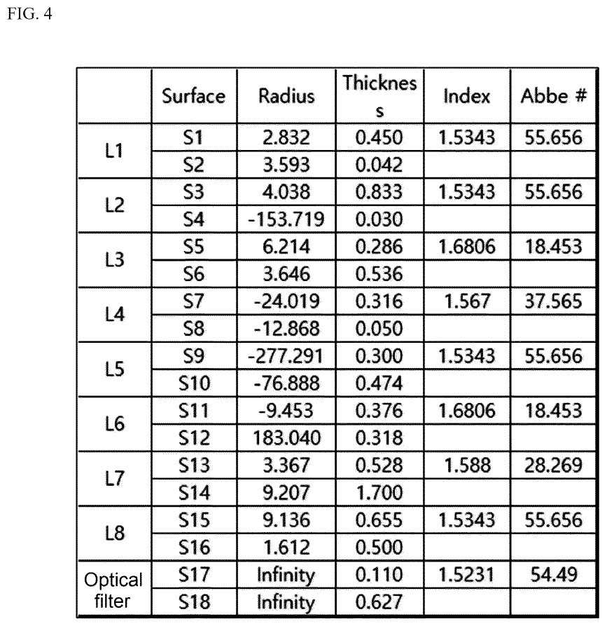

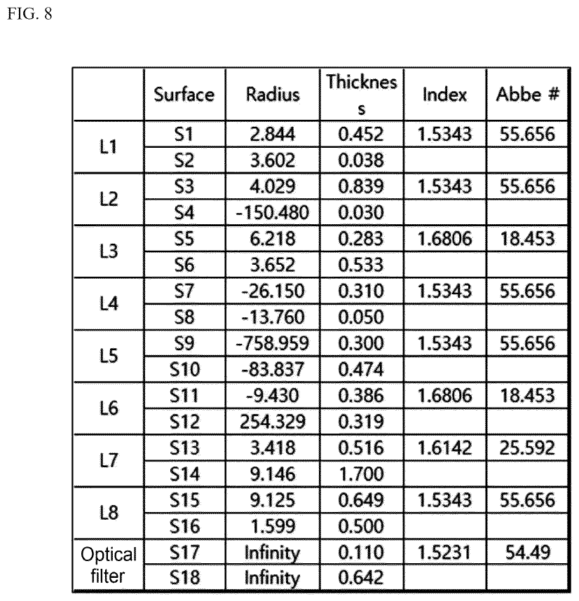

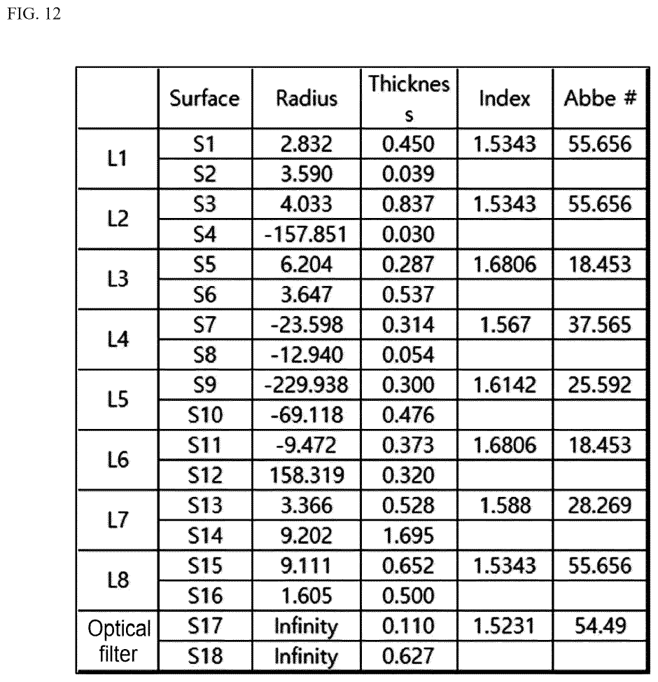

FIG. 4 is an example of lens data according to the first embodiment having the optical system of FIG. 1, FIG. 8 is an example of lens data according to the second embodiment having the optical system of FIG. 1, and FIG. 12 is an example of lens data according to the third embodiment having the optical system of FIG. 1.

As shown in FIGS. 4, 8 and 12, the optical system according to the first, second and third embodiments has a curvature radius on the optical axis OA, thickness of the lenses, the distance between the lenses, the refractive index at the d-line (588 nm), the Abbe number of the first to eighth lenses 101 to 108, and the size of the effective diameter (CA: clear aperture).

The sum of the refractive indices of the plurality of lenses 100 is 10 or more, for example, in the range of 10 to 15, the sum of the Abbe number is 300 or more, for example, in the range of 300 to 350, the sum of the center thicknesses of all lenses is 4.5 mm or less, for example, in the range of 3.5 mm to 4.5 mm, and the sum of the center distances between the first to eighth lenses on the optical axis may be 5 mm or less, smaller than the sum of the center thicknesses of the lenses, and may be in the range of 2.8 mm to 3.5 mm. In addition, the average value of the effective diameter of each lens surface of the plurality of lenses 100 may be 4 mm or more, for example, in the range of 4 mm to 6 mm, and the average of the center thickness of each lens may be 0.55 mm or less, for example, in the range of 0.35 mm to 0.55 mm. The sum of the effective diameters of the plurality of lenses 100 is the effective diameter from the first surface S1 to the sixteenth surface S16, and may be 58 mm or more, for example, in the range of 58 mm to 78 mm.

As shown in FIGS. 5, 9, and 13, at least one lens surface among the plurality of lenses 100 in the first, second, and third embodiments may include an aspheric surface having a 30th order aspherical surface coefficient. For example, the first to eighth lenses 101, 102, 103, 104, 105, 106, 107, and 108 may include lens surfaces having 30th order aspheric coefficients from the first surface S1 to the fifteenth surface S15. As described above, an aspherical surface having a 30th order aspheric coefficient (a value other than “0”) may change the aspherical shape of the peripheral portion particularly greatly, so that the optical performance of the peripheral portion of the FOV may be well corrected.

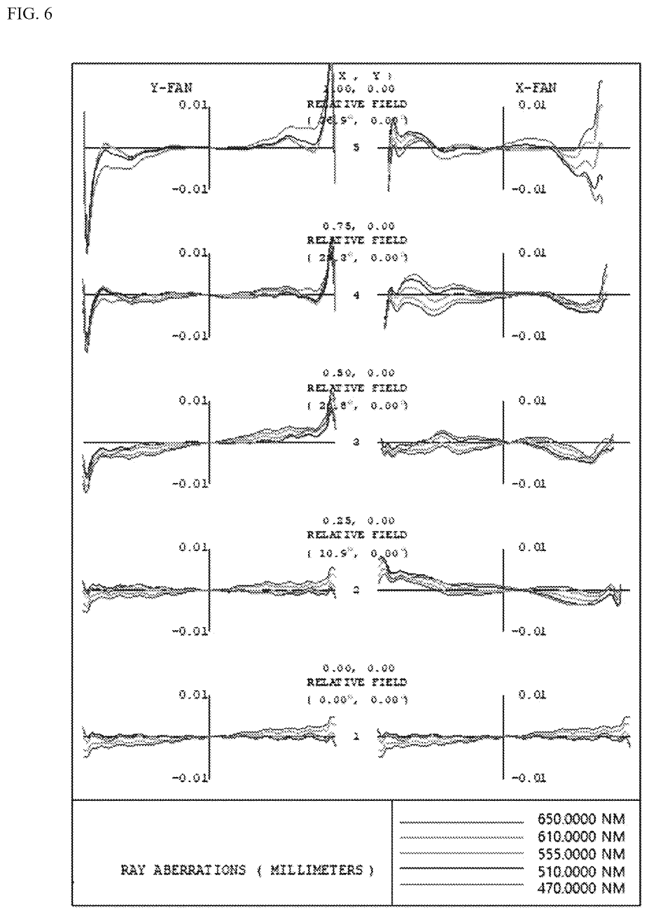

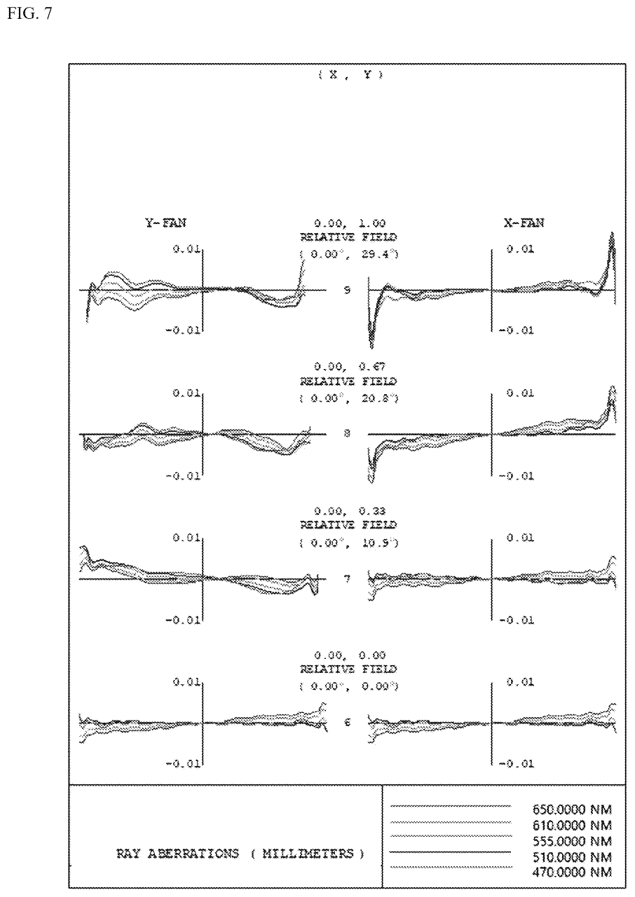

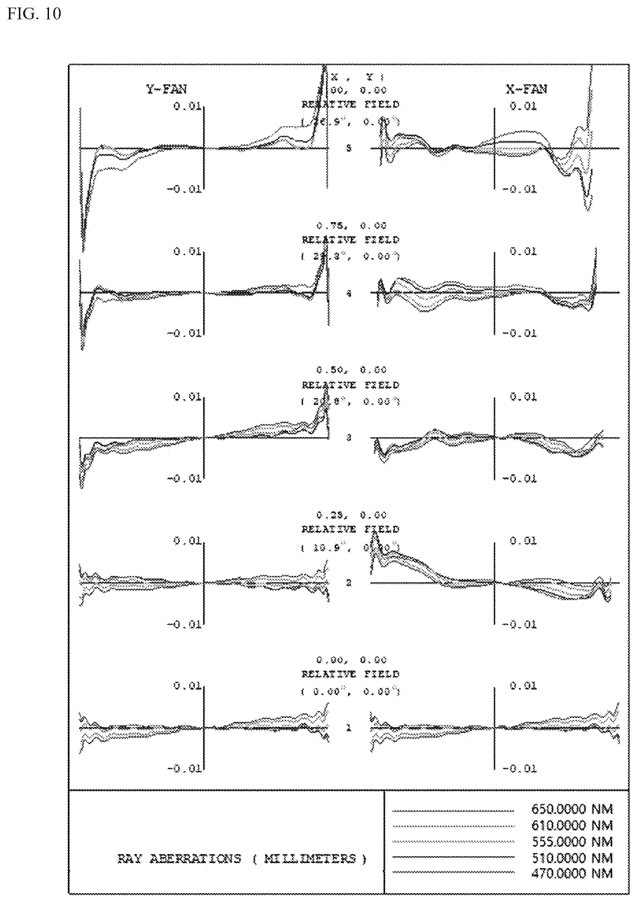

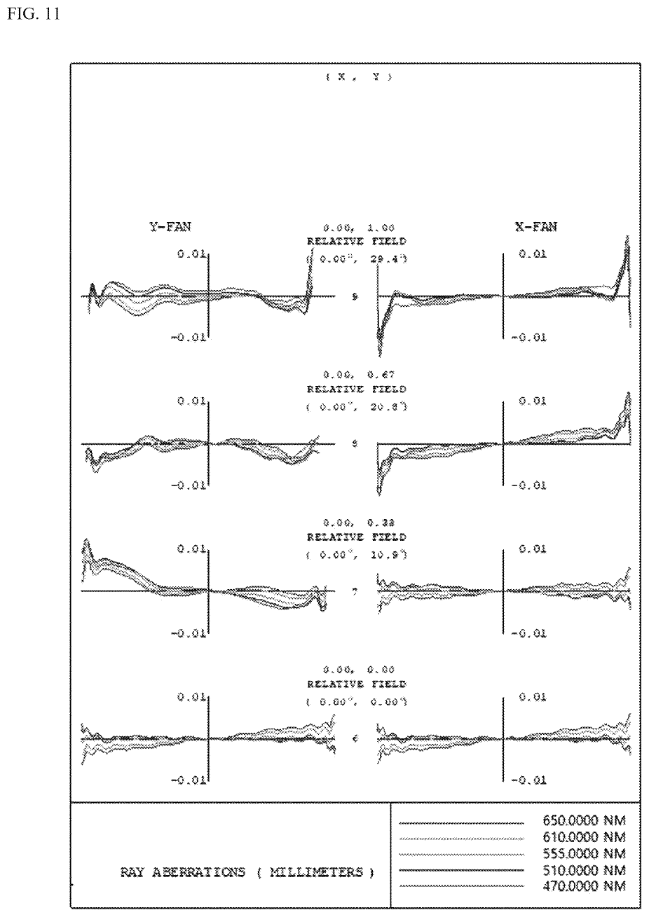

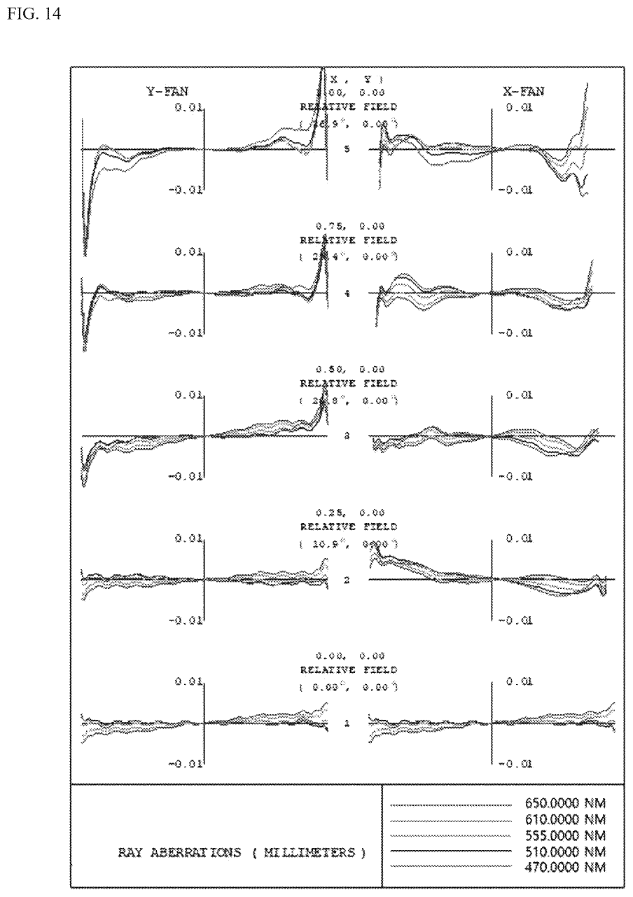

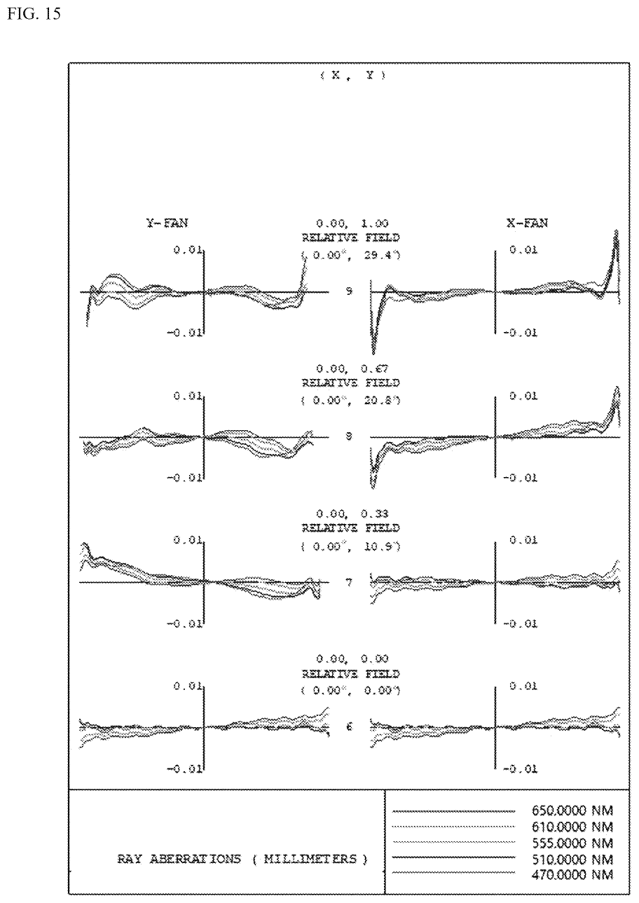

FIG. 6 is a graph showing the ray aberration characteristics in the second direction X of the optical system according to the first embodiment of the invention, and FIG. 7 is a graph showing the ray aberration characteristics in the first direction Y of the optical system according to the first embodiment, FIG. 10 is a graph showing the ray aberration characteristics in the second direction X of the optical system according to the second embodiment of the invention, and FIG. 11 is a graph showing the ray aberration characteristics in the first direction Y of the optical system according to the second embodiment of the invention, FIG. 14 is a graph showing the ray aberration characteristics in the second direction X of the optical system according to the third embodiment of the invention, and FIG. 15 is a graph showing the ray aberration characteristics in the first direction Y of the optical system according to the third embodiment of the invention.

As shown in FIGS. 6, 7, 10, 11, 14 and 15, the graphs are analysis graphs showing the lateral aberration for the first and second directions X and Y in the region where the relative field height on the optical axis is 0.0 to 1.0 in the tangential field curvature and the spherical field curvature according to the first to third embodiments, and it may be confirmed that an optical system having a good lateral aberration correction state may be obtained for light in a wavelength band of about 470 nm, about 510 nm, about 555 nm, about 610 nm, and about 650 nm. That is, the optical system 1000 according to the embodiment may have improved resolution and good optical performance not only at the center portion of the FOV but also at the periphery portion. As confirmed in the above examples, the lens system of first embodiment according to the invention is compact and lightweight with a lens configuration of eight sheets, and at the same time, spherical aberration, astigmatism, distortion aberration, chromatic aberration, and coma aberration are all well corrected, enabling high resolution implementation. Therefore, it may be used by being embedded in the optical device of the camera.

Table 1 relates to the items of the above-described equations in the optical system 1000 according to the first to third embodiments, and relates to TTL, BFL (Back focal length), F value, which is total effective focus length of the optical system 1000, ImgH, the focal lengths F1, F2, F3, F4, F5, F6, F7, F8 of each of the first to eighth lenses, the composite focal length, and the like.

TABLE 1

| Item | Embodiment 1 | Embodiment 2 | Embodiment 3 |
|---|---|---|---|
| F | 7.463 | 7.454 | 7.463 |
| F1 | 20.695 | 20.873 | 20.742 |
| F2 | 7.354 | 7.334 | 7.350 |
| F3 | −13.449 | −13.485 | −13.490 |
| F4 | 48.157 | 53.711 | 49.752 |
| F5 | 198.362 | 175.790 | 159.656 |
| F6 | −13.071 | −13.225 | −12.994 |
| F7 | 8.680 | 8.531 | 8.680 |
| F8 | −6.189 | −6.089 | −6.139 |
| F13 | 8.379 | 8.374 | 8.365 |
| F48 | −15.046 | −14.954 | −14.816 |
| FX | 7.462 | 7.454 | 7.462 |
| FY | 7.463 | 7.455 | 7.463 |
| Inf71 | 1.624 | 1.620 | 1.623 |
| Inf72 | 1.677 | 1.672 | 1.674 |
| InfX82 | 1.831 | 1.833 | 1.835 |
| InfY82 | 1.827 | 1.825 | 1.829 |
| Inf82 | 1.829 | 1.829 | 1.832 |
| D71 | 2.746 | 2.746 | 2.743 |
| D72 | 3.320 | 3.305 | 3.315 |
| D82 | 5.142 | 5.139 | 5.140 |
| ZX82 | 1.979 | 1.972 | 1.977 |
| ZY82 | 1.770 | 1.746 | 1.759 |
| Inf71 | 1.624 | 1.620 | 1.623 |
| Inf72 | 1.677 | 1.672 | 1.674 |
| InfX82 | 1.831 | 1.833 | 1.835 |
| EPD | 3.824 | 3.826 | 3.826 |
| BFL | 1.237 | 1.252 | 1.237 |
| Imgh | 7.150 | 7.150 | 7.150 |
| TTL | 8.130 | 8.130 | 8.130 |
| F-number | 1.952 | 1.948 | 1.950 |
| FOV | 86 degrees | 86 degrees | 86 degrees |

Table 2 is a table showing the effective radii (Semi-Aperture) (mm) for S1-S16 of L1 to L8, which are the first to eighth lenses according to the first, second, and third embodiments having the optical system 1000 of FIG. 1.

TABLE 2

| | | Embodiment 1- | Embodiment 2- | Embodiment 3- |
|---|---|---|---|---|
| Lens | surface | effective radius | effective radius | effective radius |
| L1 | S1 | 1.940 | 1.940 | 1.940 |
| | S2 | 1.903 | 1.900 | 1.903 |
| Stop | | 1.890 | 1.888 | 1.890 |
| L2 | S3 | 1.900 | 1.900 | 1.900 |
| | S4 | 1.840 | 1.836 | 1.840 |
| L3 | S5 | 1.722 | 1.718 | 1.721 |
| | S6 | 1.550 | 1.550 | 1.550 |
| L4 | S7 | 1.609 | 1.611 | 1.610 |
| | S8 | 1.767 | 1.777 | 1.768 |
| L5 | S9 | 2.032 | 2.038 | 2.037 |
| | S10 | 2.241 | 2.241 | 2.241 |
| L6 | S11 | 2.350 | 2.350 | 2.350 |
| | S12 | 2.580 | 2.577 | 2.579 |
| L7 | S13 | 2.746 | 2.746 | 2.743 |
| | S14 | 3.320 | 3.305 | 3.315 |
| L8 | S15 | 4.820 | 4.820 | 4.820 |
| | S16 | 5.142 | 5.139 | 5.140 |

Table 3 relates to the resultant values of Equations 1 to 70 described above in the optical system 1000 of FIG. 1. Referring to Table 3, it may be seen that the optical system 1000 satisfies at least one, two or more, or three or more of Equations 1 to 70. In detail, it may be seen that the optical system 1000 according to the embodiment satisfies all of Equations 1 to 70 above. Accordingly, the optical system 1000 may improve optical performance and optical characteristics at the center and the periphery portions of the FOV.

TABLE 3

| Equations | | Embodiment 1 | Embodiment 2 | Embodiment 3 |
|---|---|---|---|---|
| 1 | 1 < L1_CT/L3_CT < 5 | 1.57 | 1.60 | 1.57 |
| 2 | 0.5 < L3_CT/L4_CT < 2 | 0.906 | 0.911 | 0.914 |
| 3 | 1 < L8_CT/L7_CT < 2 | 1.240 | 1.258 | 1.235 |
| 4 | 0.1 < L1_CT/L8_CT < 1 | 0.265 | 0.266 | 0.266 |
| 5 | 1 < L2_CT/L8_CT < 3 | 1.272 | 1.292 | 1.284 |
| 6 | 0.01 < D12_CT/D78_CT < 1 | 0.024 | 0.022 | 0.023 |
| 7 | 1 < G1_TD/D34_CT < 5 | 3.059 | 3.080 | 3.058 |
| 8 | 1 < G2_TD/D78_CT < 5 | 2.775 | 2.767 | 2.780 |
| 9 | 0 < (L7_CT + L8_CT)/D78_CT < 1 | 0.696 | 0.685 | 0.696 |
| 10 | 0 < L1R1/L8R2 < 5 | 1.757 | 1.779 | 1.765 |
| 11 | 10 < (\|L5R1\|/L2_CT)/nL < 90 | 41.604 | 113.141 | 34.333 |
| 12 | 1 < L6_CT/D67_CT < 30 | 1.183 | 1.208 | 1.165 |
| 13 | 0 < (D78_CT)/InfX82 < 3 | 0.928 | 0.929 | 0.926 |
| 14 | 0 < (D78_CT)/InfY82 < 3 | 0.930 | 0.931 | 0.928 |
| 15 | 0 < (D78_CT)/Inf82 < 3 | 0.929 | 0.930 | 0.927 |
| 16 | 1.60 < n3 | 1.681 | 1.681 | 1.681 |
| 17 | 1.65 < AVR(n3, n6) < 1.75 | 1.681 | 1.681 | 1.681 |
| 18 | 1 < CA_L1S1/CA_L3S1 < 2 | 1.127 | 1.129 | 1.127 |
| 19 | 1 < CA_L8S2/CA_L4S2 < 5 | 2.910 | 2.892 | 2.907 |
| 20 | 0.2 < CA_L3S2/CA_L4S1 < 2 | 0.963 | 0.962 | 0.963 |
| 21 | 0.1 < CA_L6S2/CA_L8S2 < 2 | 0.502 | 0.502 | 0.502 |
| 22 | 1 < L7R1/L7_CT < 10 | 6.372 | 6.372 | 6.372 |
| 23 | 1 < \|L6R1/L8R1\| < 5 | 1.035 | 1.035 | 1.035 |
| 24 | 0 < L_CT_Max/Air_CT_Max < 5 | 0.49 | 0.49 | 0.49 |
| 25 | 0.5 < ΣL_CT/ΣAir_CT < 2 | 1.189 | 1.189 | 1.189 |
| 26 | 10 < ΣIndex < 30 | 12.653 | 12.653 | 12.653 |
| 27 | 10 < ΣAbb/ΣIndex < 50 | 25.714 | 25.714 | 25.714 |
| 28 | 0.5 < CA_L1S1/CA_min < 2 | 1.252 | 1.252 | 1.252 |
| 29 | 1 < CA_max/CA_min < 5 | 3.318 | 3.315 | 3.316 |
| 30 | 1 < CA_max/CA_Aver < 3 | 2.085 | 2.084 | 2.084 |
| 31 | 0.1 < CA_min/CA_Aver < 1 | 0.628 | 0.629 | 0.629 |
| 32 | 0.1 < CA_max/(2*ImgH) < 1 | 0.719 | 0.719 | 0.719 |
| 33 | 0.5 < TD/CA_max < 1.5 | 0.670 | 0.671 | 0.671 |
| 34 | 0 < F/L8R2 < 10 | 4.628 | 4.662 | 4.649 |
| 35 | 1 < F/L1R1 < 10 | 2.635 | 2.621 | 2.635 |
| 36 | 0 < EPD/L8R2 < 10 | 0.422 | 0.418 | 0.420 |
| 37 | 0.5 < EPD/L1R1 < 8 | 1.350 | 1.344 | 1.351 |
| 38 | −3 < F1/F3 < 0 | −1.539 | −1.548 | −1.538 |
| 39 | 1 < F13/F < 5 | 1.123 | 1.123 | 1.121 |
| 40 | 0 < \|F48/F13\| < 10 | 1.796 | 1.786 | 1.771 |
| 41 | 2 < TTL < 20 | 8.130 | 8.130 | 8.130 |
| 42 | 2 < ImgH | 7.150 | 7.150 | 7.150 |
| 43 | BFL < 2.5 | 1.237 | 1.252 | 1.237 |
| 44 | 2 < F < 20 | 7.463 | 7.454 | 7.463 |
| 45 | FOV < 120 | 86.000 | 86.000 | 86.000 |
| 46 | 0.5 < TTL/CA_max < 2 | 0.791 | 0.791 | 0.791 |
| 47 | 0.4 < TTL/(ImgH*2) < 0.7 | 0.569 | 0.569 | 0.569 |
| 48 | 0.01 < BFL/ImgH < 0.5 | 0.173 | 0.175 | 0.173 |
| 49 | 4 < TTL/BFL < 10 | 6.574 | 6.493 | 6.575 |
| 50 | 0.5 < F/TTL < 1.5 | 1.089 | 1.091 | 1.089 |
| 51 | 3 < F/BFL < 10 | 6.035 | 5.953 | 6.036 |
| 52 | 0.1 < F/ImgH < 3 | 1.044 | 1.043 | 1.044 |
| 53 | 1 < F/EPD < 3 | 1.952 | 1.949 | 1.951 |
| 54 | 0.5 < TTL/(D82 × 2) < 1.5 | 0.791 | 0.791 | 0.791 |
| 55 | 0.5 < F2/F < 1.5 | 0.985 | 0.984 | 0.985 |
| 56 | −5 < F2/F3 < 0 | −0.547 | −0.544 | −0.545 |
| 57 | 0.8 < F2/F12 < 1.8 | 1.297 | 1.293 | 1.296 |
| 58 | 0.5 < F12/F < 1.5 | 0.760 | 0.761 | 0.760 |
| 59 | 0 < L2R1/\|L2R2\| < 1 | 0.026 | 0.027 | 0.026 |
| 60 | 0 < L3R2/\|L3R1\| < 1 | 0.587 | 0.587 | 0.588 |
| 61 | 0.8 < n2/n3 < 1.2 | 0.913 | 0.913 | 0.913 |
| 62 | 1 < L2_CT/L3_CT < 5 | 2.914 | 2.966 | 2.917 |
| 63 | 0.7 < Inf71/Inf72 < 1.2 | 0.968 | 0.969 | 0.970 |
| 64 | 0.7 < Inf71/Inf82 < 1.2 | 0.888 | 0.886 | 0.886 |
| 65 | 0.3 < Inf71/D71 < 1.0 | 0.591 | 0.590 | 0.592 |
| 66 | 0.3 < Inf72/D72 < 1.0 | 0.505 | 0.506 | 0.505 |
| 67 | 0.2 < Inf82/D82 < 0.8 | 0.356 | 0.356 | 0.356 |
| 68 | −0.1 < FX − FY < 0.1 | −0.001 | −0.0009 | −0.001 |
| 69 | −0.1 < InfX82 − InfY82 < 0.1 | 0.004 | 0.008 | 0.006 |
| 70 | −0.5 < ZX82 − ZY82 < 0.5 | 0.209 | 0.226 | 0.219 |

FIG. 17 is a view showing a distortion grid for a real FOV and a Parax FOV for a horizontal FOV (Field of View) and vertical FOV in the optical system of FIG. 1. It is a distortion grid that occurs when light is emitted from the optical system according to the first to third embodiments, and it may be seen that distortion occurs uniformly toward the left and right and upper edges of the horizontal FOV and vertical FOV.

FIG. 18 is a diagram illustrating that a camera module according to an embodiment is applied to a mobile terminal.

Referring to FIG. 18, the mobile terminal 1 may include a camera module 10 provided on the rear side. The camera module 10 may include an image capturing function. In addition, the camera module 10 may include at least one of an auto focus function, a zoom function, and an OIS function.

The camera module 10 may process a still image or video frame obtained by the image sensor 300 in a shooting mode or a video call mode. The processed image frame may be displayed on a display unit (not shown) of the mobile terminal 1 and may be stored in a memory (not shown). In addition, although not shown in the drawings, the camera module may be further disposed on the front side of the mobile terminal 1.

For example, the camera module 10 may include a first camera module 10A and a second camera module 10B. At this time, at least one of the first camera module 10A and the second camera module 10B may include the above-described optical system 1000. Accordingly, the camera module 10 may have a slim structure and may have improved distortion and aberration characteristics. In addition, the camera module 10 may have good optical performance even in the center and periphery portions of the FOV.

In addition, the mobile terminal 1 may further include an auto focus device 31. The auto focus device 31 may include an auto focus function using a laser. The auto-focus device 31 may be mainly used in a condition in which an auto-focus function using an image of the camera module 10 is degraded, for example, a proximity of 10 m or less or a dark environment. The autofocus device 31 may include a light emitting unit including a vertical cavity surface emitting laser (VCSEL) semiconductor device and a light receiving unit such as a photodiode that converts light energy into electrical energy.

In addition, the mobile terminal 1 may further include a flash module 33. The flash module 33 may include a light emitting element emitting light therein. The flash module 33 may be operated by a camera operation of a mobile terminal or a user's control.

Features, structures, effects, etc. described in the embodiments above are included in at least one embodiment of the invention, and are not necessarily limited to only one embodiment. Furthermore, the features, structures, and effects illustrated in each embodiment may be combined or modified with respect to other embodiments by those skilled in the art in the field to which the embodiments belong. Therefore, contents related to these combinations and variations should be construed as being included in the scope of the invention.

In addition, although described based on the embodiments, this is only an example, this invention is not limited, and it will be apparent to those skilled in the art that various modifications and applications not illustrated above are possible without departing from the essential characteristics of this embodiment. For example, each component specifically shown in the embodiment may be modified and implemented. And the differences related to these modifications and applications should be construed as being included in the scope of the invention as defined in the appended claims.

1-22. (canceled)

23. An optical system comprising:
first to eighth lenses disposed along an optical axis from an object side toward a sensor side,
wherein the first lens has positive (+) or negative (−) refractive power on the optical axis,
wherein the second lens has positive (+) refractive power on the optical axis,
wherein the third lens has negative (−) refractive power on the optical axis,
wherein the seventh lens has positive (+) refractive power on the optical axis,
wherein the eighth lens has negative (−) refractive power on the optical axis,
wherein at least one of an object-side surface and a sensor-side surface of the seventh lens has at least one critical point,
wherein each of an object-side surface and a sensor-side surface of the eighth lens has a critical point,
wherein at least one of the object-side surface and the sensor-side surface of the eighth lens has a freeform surface shape in which a lens surface orthogonal to the optical axis in a first direction and a lens surface orthogonal to the optical axis in a second direction are asymmetrical, wherein the freeform surface has symmetrical lens surfaces on both sides of the first direction with respect to the optical axis and symmetrical lens surfaces on both sides of the second direction with respect to the optical axis, and
wherein a center thickness of the second lens is a maximum of center thicknesses of the lenses of the optical system.

24. The optical system of claim 23, wherein each of the object-side surface and the sensor-side surface of the seventh lens has the critical point, and
wherein the critical point of the object-side surface of the seventh lens is located closer to the optical axis than the critical point of the sensor-side surface of the seventh lens.

25. The optical system of claim 23, wherein the object-side surface of the seventh lens has a convex shape on the optical axis, and
wherein the sensor-side surface of the seventh lens has a concave shape on the optical axis.

26. The optical system of claim 25, wherein a sensor-side surface of the third lens has a concave shape on the optical axis, and
wherein the object-side surface of the fourth lens has a concave shape on the optical axis.

27. The optical system of claim 25, wherein an object-side surface of the fifth lens has a concave shape on the optical axis, and has a maximum value of absolute values of curvature radius of lens surfaces of the optical system.

28. The optical system of claim 23, wherein an object-side surface of the second lens has a convex shape on the optical axis, and a sensor-side surface of the second lens has a convex shape on the optical axis.

29. The optical system of claim 23, wherein the sensor-side surface of the eighth lens has a freeform surface, and
wherein a distance from the optical axis to the critical point of the sensor-side surface of the eighth lens in the first direction are different from a distance from the optical axis to the critical point of the sensor-side surface of the eighth lens in the second direction.

30. The optical system of claim 29, wherein the object-side surface of the eighth lens has an aspheric shape.

31. The optical system of claim 23, wherein an optical axis distance between the seventh lens and the eighth lens is larger than a sum of center thickness of the seventh lens and a center thickness of the eighth lens, and is 1.8 times or more than a thickness having a maximum thickness among the first to eighth lenses.

32. The optical system of claim 29, wherein a straight distance InfX82 from the optical axis to the critical point of the sensor-side surface of the eighth lens in the first direction and a straight distance InfY82 from the optical axis to the critical point of the sensor-side surface of the eighth lens in the second direction are different from each other, and
wherein the following Equations satisfy:
$$- 0.1 < InfX 82 - InfY 82 < 0.1 \qquad Equation$$
$$0.4 < TTL / ( Imgh * 2 ) < 0.7 \qquad Equation$$
(TTL is a distance in the optical axis from an apex of the object-side surface of the first lens to an image surface of an image sensor, and Imgh is ½ of a maximum diagonal length of the image sensor).

33. An optical system comprising:
a first lens group having three or less lenses on an object side; and
a second lens group having five or less lenses on a sensor side of the first lens group,
wherein the first lens group has a positive (+) refractive power on the optical axis,
wherein the second lens group has a negative (−) refractive power on the optical axis,
wherein a number of lenses of the second lens group is less than twice a number of lenses of the first lens group,
wherein a lens surface closest to the second lens group among the lens surfaces of the first and second lens groups has a minimum effective diameter,
wherein a last lens closest to an image sensor among lens surfaces of the first and second lens groups has a maximum effective diameter,
wherein a sensor-side surface closest to the second lens group among the first lens groups has a concave shape,
wherein an object-side surface closest to the first lens group among the second lens group has a concave shape,
wherein a sensor-side surface of the last lens has a freeform surface shape with a critical point,
wherein a sensor-side surface closest to the image sensor has a freeform surface shape in which a lens surface orthogonal to the optical axis in a first direction and a lens surface orthogonal to the optical axis in a second direction are asymmetrical, and
wherein the freeform surface has symmetrical lens surfaces on both sides of the first direction with respect to the optical axis and symmetrical lens surfaces on both sides of the second direction with respect to the optical axis.

34. The optical system of claim 33, wherein a straight distance InfX82 from the optical axis to the critical point on the sensor-side surface of the last lens in the first direction and a straight distance InfY82 from the optical axis to the critical point of the sensor-side surface of the last lens in the second direction are different from each other, and the following Equation satisfies:
$$- 0.1 < InfX 82 - InfY 82 < 0.1 . \qquad Equation$$

35. The optical system of claim 33, wherein a total focal length FX in the first direction and a total focal length FY in the second direction are different from each other, and the following Equation satisfies:
$$- 0.1 < FX - FY < 0.1 . \qquad Equation$$

36. The optical system of claim 33, wherein the following Equation satisfies:
$$0.4 < TTL / ( Imgh * 2 ) < 0.7 \qquad Equation$$
(TTL (Total track length) is a distance in the optical axis from an apex of an object-side surface of a first lens to an image surface of the image sensor, and Imgh is ½ of a maximum diagonal length of the image sensor).

37. The optical system of claim 33, wherein the first lens group includes first to third lenses disposed along the optical axis from the object side toward the object side,
wherein the second lens group includes fourth to eighth lenses disposed along the optical axis from the object side toward the sensor side,
wherein each of the object-side surface and the sensor-side surface of the seventh lens has a critical point, and
wherein an object-side surface of the eighth lens has a critical point.

38. The optical system of claim 37, wherein a straight distance Inf71 from the optical axis to the critical point of the object-side surface of the seventh lens and a straight distance Inf72 from the optical axis to the critical point of the sensor-side surface of the seventh lens are satisfy the following Equation:
Equation: 0.7<Inf71/Inf72<1.2, wherein the straight distance Inf71 from the optical axis to the critical point of the object-side surface of the seventh lens and an average Inf82 of straight distances InfX82 and InfY82 from the optical axis to the critical points of the sensor-side surface of the eighth lens in X and Y directions are satisfy the following Equation:
$$0.7 < Inf 71 / InfY 82 < 1.2 . \qquad Equation$$

39. The optical system of claim 37, wherein the seventh lens has a positive (+) refractive power and has a convex object-side surface and a concave sensor-side surface,
wherein the eighth lens have negative (−) refractive power and has a convex object-side surface and a concave sensor-side surface, wherein an average Inf82 of straight distances InfX82 and InfY82 to the critical points of the sensor-side surface of the eighth lens in X and Y directions and a straight distance D82 from the optical axis of the eighth lens to an end of the effective region are satisfy the following Equation:
$$0.2 < Inf 82 / D82 < 0.8 . \qquad Equation$$

40. The optical system of claim 37, wherein a center thickness L2_CT of the second lens and a center thickness L3_CT of the third lens satisfy the following Equation:
$$1 < L 2 \_CT / L 3 \_CT < 5. \qquad Equation$$

41. The optical system of claim 40, wherein an optical axis distance between the seventh lens and the eighth lens is 1.8 times or more of the center thickness of the second lens.

42. A camera module comprising:
an image sensor; and
a filter disposed between the image sensor and a last lens of an optical system,
wherein the optical system includes an optical system according to claim 23,
wherein the following Equation satisfies:
$$0.5 < F / TTL < 1.2 \qquad Equation$$
(F is an average of a total focal lengths in two directions orthogonal to the optical axis of the optical system, and TTL is a distance in the optical axis from an apex of an object-side surface of the first lens to an image surface of the image sensor).
